(19) United States
(12) Patent Application Publication
(10) Pub. No.: US 2008/0021216 A1
(43) Pub. Date: Jan. 24, 2008

(54) Molecular Platforms Having Transition Metal Grid Complexes for a Binary Information Recording Medium

(76) Inventors: Laurence K. Thompson, St. John's (CA); Zhiqiang Xu, Parsippany, NJ (US)

Correspondence Address: MCKEE, VOORHEES & SEASE, P.L.C., 801 GRAND AVENUE, SUITE 3200, DES MOINES, IA, 50309-2721, US

(21) Appl. No.: 11/569,636

(22) PCT Filed: May 26, 2005
(86) PCT No.: PCT/CA05/00787

§ 371 Date: Jul. 31, 2007

Related U.S. Application Data
(60) Provisional application No. 60/574,522, filed on May 26, 2004.

(51) Int. Cl. C07F 1/08; B32B 3/02; C07F 13/00; C07F 15/02; C07F 15/04; C07F 15/06

(52) U.S. Cl. 544/225; 428/64.2; 546/6

(57) ABSTRACT

The present invention provides a novel class of molecular coordination compounds, and more particularly, square supramolecular metal coordination grids of the formula (I): [Mₐ²(L)₂ₐ]X_{z} (I), wherein M is a transition metal: a is 3, 4, 5 or 6; X is a counterion; z is 2 to 60 and L is as defined in the application. The present invention also provides the use of the square supramolecular metal coordination grids in a binary information recording medium, and a method of forming such a binary information recording medium.

### FIELD OF THE INVENTION

The invention relates to a novel class of molecular coordination compounds, and more particularly, relates to square supramolecular metal coordination grids. The present invention also relates to use of the compounds and grids, particularly in a binary information recording medium, and a method of forming the binary information recording medium.

### BACKGROUND OF THE INVENTION

In the past few years, the computer industry has been trying hard to develop new media for data storage since the “super-paramagnetic limit” for magnetic storage is fast-approaching. This refers to the limit on miniaturization of the magnetic metal oxide particles which are capable of being magnetized on a hard drive disk, for instance, without the loss of information through thermal re-orientation ‘erasure’ effects. Currently, the “super-paramagnetic limit” for magnetic storage is of the order of 100's of nanometers. Molecules have potential for use in data storage since they have dimensions which are much smaller than the magnetic metal oxide particles.

The use of transition metal complexes to store information in optical information storage devices is disclosed in U.S. Pat. No. 6,500,510 B1 issued to Sanders et al. on Dec. 31, 2002. The binary data recording medium as taught therein includes a substrate and a recording layer on the substrate. The recording layer includes an organometallic transition metal complex which absorbs at a first wavelength and when the complex is subjected to a light-induced excited state resulting in a reaction product in the recording layer, it absorbs light having a second, different wavelength. The light absorption of the first wavelength is assigned a first value, and light absorption of the second wavelength is assigned a second value in which the first and second values correspond to binary code. The transition metal complexes investigated by Sanders et al. are mononuclear and binuclear complexes in which the metal used is ruthenium and the ligands used are bipyridyl. As is known to those skilled in the art, complexes of this type are photochromic. The resultant optical information storage device provided by Sanders et al. is thus based on a polymeric matrix and on metal oxides with adsorbed mononuclear or binuclear photochromic ruthenium transition metal complexes.

Another approach to data storage has been investigated by P. Vettiger et al. in IBM J. Res. Develop. 2000, 44, 323. Individual molecules have been thermochemically addressed using Atomic Force Microscopy (AFM) tip, which can be resolved to the atomic level. A 2D AFM cantilever storage technique with large 32×32 array chips using parallel technology (millipede) based on thermo-mechanical read-write methods on nanometer thick polymer films has been reported. In this study, storage densities of 100's of Gb/in² have been demonstrated by Vettiger et al., as well as data bit images of 40 nm diameter with 120 nm pitch. Although the study shows that nanometer scale regions of a medium can be functionalized and that AFM-based approach clearly has potential in the storage of data, a limiting factor in this technique is the read-write speed which is inferior to current magnetic based methods.

A further alternative approach to address individual molecules on a surface using Scanning Tunneling Microscopy (STM) has been reported by A. Semenov et al. in Agnew. Chem. Int. Ed. 1999, 38(17), 2547. The study reported [2×2] cobalt (II) grids based on substituted pyrimidine ligands and highlighted surface applications on highly oriented pyrolitic graphite. The surface layers have been examined using STM imagery, and the individual molecules can be removed from the surface by a −0.5V charge applied to the probe tip.

Since molecules having the property of reversible magnetization at room temperature are not known yet, there remains a need for new classes of molecular coordination compounds which can be simply deposited on a surface so as to provide a nanometer scale device which is capable of storing binary information.

### SUMMARY OF THE INVENTION

A novel class of molecular coordination compounds with suitable electrochemical properties has been found to be potentially useful in a binary information recording medium.

Accordingly, the present invention relates to square supramolecular metal coordination grids comprising the formula (I):
[Mₐ_{²}(L)₂ₐ]X_{z} (I)
in which
M is a transition metal;
a is 3, 4, 5 or 6;
X is a counterion; and
z is 2 to 60;
L is selected from at least one of the formulas: 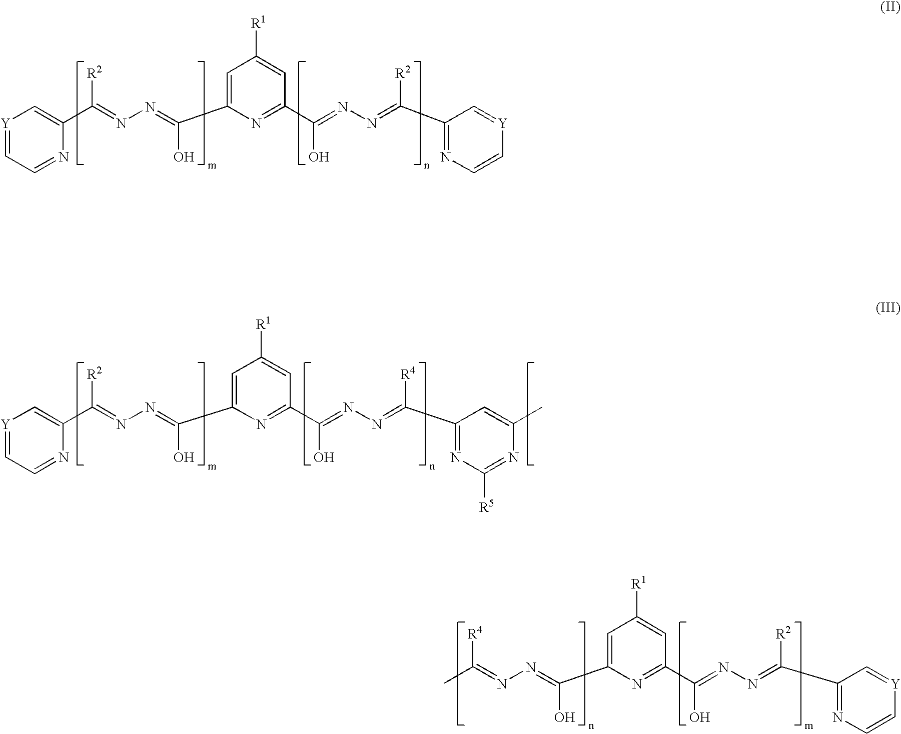
   in which
Y is CH or N;
R¹ is selected from the group consisting of H, Cl, Br, I, OH, C₁₋₆alkyl, (O)C₁₋₆alkyl, S⁻ or SR³;
R² is selected from the group consisting of H, NH₂, C₁₋₆alkyl, aryl and heteroaryl, said latter three groups being optionally substituted;
R³ is selected from the group consisting of NH₄⁺, C₁₋₆alkylCOOH, C₁₋₆alkyl, C₁₋₆alkylaryl, aryl and heteroaryl, said latter five groups being optionally substituted;
R⁴ is H, NH₂, C₁₋₆alkyl, aryl and heteroaryl, said latter three groups being optionally substituted;
R⁵ is selected from the group consisting of H, NH₂, OH, C₁₋₆alkyl, aryl and heteroaryl, said latter three groups being optionally substituted;
m and n is independently selected from 1 or 2 when L is of the formula (II);
m is 0 and n is 1 or 2 when L is of the formula (IlI) or m is 1 and n is 1 when L is of the formula (III);
with the proviso that the sum of m and n is one less than the value of a when L is of the formula (II);
with the proviso that the sum of m and n is two less than the value of a when L is of the formula (III), and;
with the proviso that when m is 0, Y is CH.

The present invention further relates to the use of a square supramolecular metal coordination grid of the formula (I) as described immediately above in a binary information recording medium.

Further, the present invention relates to a binary information recording medium comprising a substrate and a recording medium having a monolayer of a square supramolecular metal coordination grid of the formula (I) deposited on the substrate, in which the square supramolecular metal coordination grid comprises an oxidized state and a reduced state. The oxidized state and the reduced state together correspond to binary ‘on’ or ‘off’ condition.

The present invention also relates to a method of forming a binary information recording medium comprising the steps of providing a substrate, and depositing a monolayer of a square supramolecular metal coordination grid of the formula (I), in which the square supramolecular metal coordination grid has an oxidized state and a reduced state. The oxidized state and the reduced state together correspond to binary ‘on’ or ‘off’ condition.

It has been found by the present inventors that a monolayer of square supramolecular metal coordination grid having individual molecular dimensions in the nanometers range can be deposited on a substrate, and form closely spaced monolayer arrangements with very high surface density. The square supramolecular metal coordination grid has an oxidized state and a reduced state. The oxidized state and the reduced state together correspond to binary ‘on’ or ‘off’ condition.

The present inventors have found that because of the molecular dimensions provided by the supramolecular metal coordination grids, the supramolecular metal coordination grids would provide very much larger storage densities than the currently available super-paramagnetic storage approach. Nanometer scale devices capable of storing binary information can be provided based on the electronic states of the square supramolecular metal coordination grids.

Other features and advantages of the present invention will become apparent from the following detailed description. It should be understood, however, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF THE DRAWINGS

Embodiments of the invention will be described in relation to the drawings in which:

FIG. 1a is diagrammatic representation of a series of square supramolecular metal coordination grids in accordance with the present invention;

FIG. 1b structural representation of one ligand showing the metal binding sites;

FIG. 1c is a magnetic exchange model in M₉ grids;

FIG. 2 is a structural representation of the cation in compound 1;

FIG. 3a is a core structure of the cationic M₉ grid fragment of the compound 2;

FIG. 3b is a core structure of the other cationic M₉ grid fragment of the compound 2;

FIG. 3c is the core structure of the compound 2 showing the two associated grids of FIGS. 3a and 3b;

FIG. 3d is an extended structural representation showing the Mn(3)-Mn(16) and Mn(7)-Mn(12) contacts;

FIG. 4 is a structural representation of the cation of the compound 3 (30% thermal ellipsoids; POVRAY® format);

FIG. 5 is the core structure of the compound 3;

FIG. 6 is the structural representation of the cation of the compound 4 (30% thermal ellipsoids; POVRAY® format);

FIG. 7 is the core structure of the compound 4;

FIG. 8 is the structural representation of the cation of the compound 5 (30% thermal ellipsoids);

FIG. 9 is the core structure of the compound 5;

FIG. 10a is the core structure of the compound 6;

FIG. 10b is the core structure of the compound 21;

FIG. 11 is the cyclic voltammetry for the compound 8 (CH₃CN, 1.0 mM, TEAP (0.1 M), Ag/AgCl);

FIG. 12a is the differential pulse voltammetry for the compound 8 (CH₃CN, 1.0 mM, TEAP (0.1 M), Ag/AgCl), using 20 mV/s scan rate, 50 mV pulse amplitude and 50 ms pulse width;

FIG. 12b compares differential pulse voltammetry for 8, 10 and 13, under similar conditions.

FIG. 12c is the differential pulse voltammetry for the compound 15 (CH₃CN, 1.0 mM, TEAP (0.1 M), Ag/AgCl), using 20 mV/s scan rate, 50 mV pulse amplitude and 50 ms pulse width;

FIG. 13 shows the magnetic properties of the compound 1 expressed as μₘₒₗ versus temperature. The solid line represents a fit to eqns. 2-4 with g=2.028, J=−4.7 cm⁻¹, α=0.001, TIP=0 emu.mol⁻¹, θ=0 K (10²R=1.9);

FIG. 14 is the spin dipole model for an anti-ferromagnetically coupled Mn(II)₉ grid system (J>>J′);

FIG. 15 shows the magnetic properties of the compound 2 expressed as μₘₒₗ versus temperature. The solid line represents a fit to eqns. 2-4 with g=1.992, J=−4.7 cm⁻¹, α=0.001, TIP=0 emu.mol⁻¹, θ=−1K (10²R=2.8);

FIG. 16 shows the magnetic properties of the compound 5 expressed as μₘₒₗ versus temperature. The solid line represents a fit to eqns. 2-4 with g=2.038, J=−4.1 cm⁻¹, α=0.0005, TIP=0 emu.mol⁻¹, θ=−1K (10²R=1.5);

FIG. 17 shows the magnetic properties of compound 6 expressed as χₘₒₗ versus temperature, and μₘₒₗ versus temperature;

FIG. 18 shows the magnetization data as a function of field at 2 K for the compound 6. Solid line calculated using the standard Brillouin function for an S=1 system up to 3.5 T;

FIG. 19 shows the magnetic properties of compound 14 expressed as χₘₒₗ versus temperature.

FIG. 20 is the core structure of the compound 8 (POVRAY®), showing the projection of the chlorine atoms (green=chlorine, black=carbon, blue=nitrogen, red=oxygen, magenta=manganese);

FIG. 21 is the STM image of compound 8 on Au(111) at dilute coverage.

FIG. 22 is the STM image of monolayer coverage of the compound 12 on Au(111) (scan size 100 nm×100 nm; tunneling conditions; 50 mV, 60 pA, ˜10⁻⁵ M concentration);

FIG. 23 is the surface model for the compound 12, based on the structure of the chloro-complex 8; and

FIG. 24 is a diagram of a disc model showing the charged tips (e.g. AFM tip or related device) tracking on a spinning disc with current response producing read/write signal as an individual molecule is oxidized or reduced.

### DETAILED DESCRIPTION OF THE INVENTION

This present application relates to a novel class of molecular coordination compounds.

The present invention relates to a square supramolecular metal coordination grid comprising the formula (I):
[Mₐ_{²}(L)₂ₐ]X_{z} (I)
in which
M is a transition metal;
a is 3, 4, 5 or 6;
X is a counterion; and
z is 2 to 60;
L is selected from at least one of the formulas: 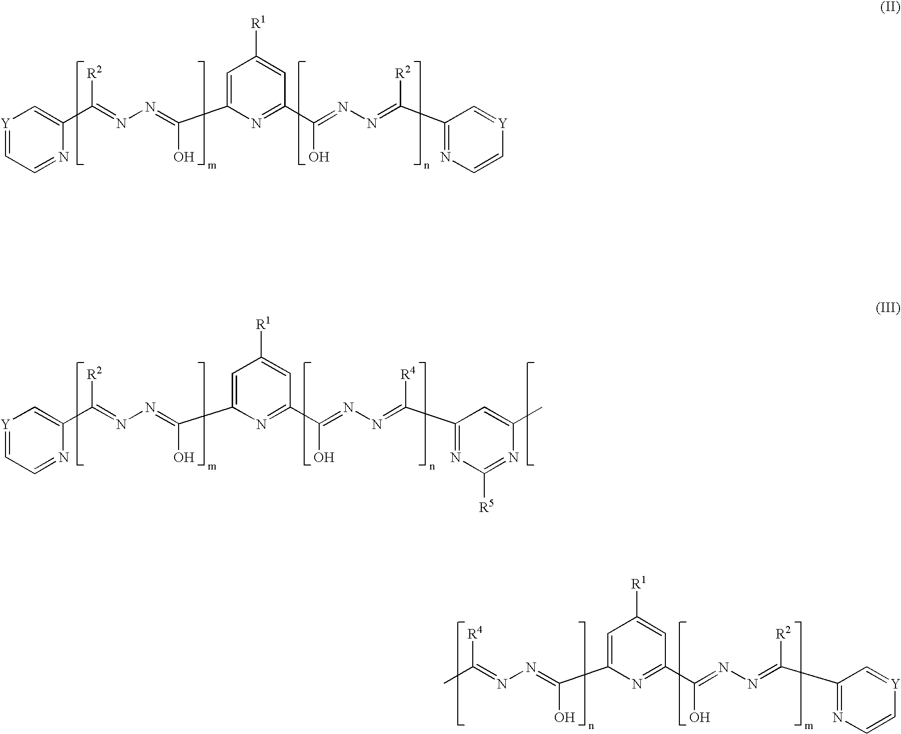
   in which
Y is CH or N;
R¹ is selected from the group consisting of H, Cl, Br, I, OH, C₁₋₆alkyl, (O)C₁₋₆alkyl, S⁻ or SR³;
R² is selected from the group consisting of H, NH₂, C₁₋₆alkyl, aryl and heteroaryl, said latter three groups being optionally substituted;
R³ is selected from the group consisting of NH₄⁺, C₁₋₆alkylCOOH, C₁₋₆alkyl, C₁₋₆alkylaryl, aryl and heteroaryl, said latter five groups being optionally substituted;
R⁴ is H, NH₂, C₁₋₆alkyl, aryl and heteroaryl, said latter three groups being optionally substituted;
R⁵ is selected from the group consisting of H, NH₂, OH, C₁₋₆alkyl, aryl and heteroaryl, said latter three groups being optionally substituted;
m and n is independently selected from 1 or 2 when L is of the formula (II);
m is 0 and n is 1 or 2 when L is of the formula (III) or m is 1 and n is 1 when L is of the formula (III);
with the proviso that the sum of m and n is one less than the value of a when L is of the formula (II);
with the proviso that the sum of m and n is two less than the value of a when L is of the formula (III), and;
with the proviso that when m is 0, Y is CH.

As used herein, the term “C₁₋₆alkyl” refers to a straight or branched chain alkyl group containing from 1 to 10 carbon atoms, and includes, methyl, ethyl, propyl, isopropyl, n-butyl, isobutyl, t-butyl, pentyl, hexyl, and the like.

The term “aryl” as used herein refers to a monocyclic aromatic ring containing 6 carbon atoms, where the aromatic ring may be substituted with carboxylic acid, ester or amine functions.

The term “heteroaryl” as used herein means unsubstituted or substituted monocyclic heteroaromatic radicals containing from 5 or 6 atoms, of which 1-2 atoms may be a heteroatom selected from the group consisting of S, O and N, and includes furanyl, thienyl, pyrrolo, pyridyl, and the like.

The present invention further relates to the use of a square supramolecular metal coordination grid of the formula (I) in a binary information recording medium.

In embodiments of the present invention, the metal M is selected from the group consisting of Mn, Fe, Co, Ni and Cu.

In embodiments of the present invention, the square supramolecular metal coordination grid of the formula (I) includes those grids in which X is selected from the group consisting of Cl⁻, Br⁻, I⁻, NCS⁻, NO₃⁻, ClO₄⁻, BF₄⁻, PF₆⁻, N₃⁻, N(CN)₂⁻, CF₃SO₃⁻ and SO₄²⁻.

In embodiments of the present invention, the square supramolecular metal coordination grid of the formula (I) includes those grids in which R¹ is H, Cl, OH, OCH₃, S⁻ and SR³ in which R³ is as defined above.

In embodiments of the present invention, the square supramolecular metal coordination grid of the formula (I) includes those grids in which R² is selected from the group consisting of H, NH₂, methyl, phenyl and pyridyl.

In embodiments of the present invention, the square supramolecular metal coordination grid of the formula (I) includes those grids in which R² is selected from the group consisting of H, NH₂, methyl, phenyl and pyridyl, and Y is CH.

In embodiments of the present invention, the square supramolecular metal coordination grid of the formula (I) includes those grids in which R² is NH₂ and Y is N.

In embodiments of the present invention, the square supramolecular metal coordination grid of the formula (I) includes those grids in which R³ is selected from the group consisting of NH₄⁺, C₁₋₄alkylCOOH, C₁₋₄alkyl, benzyl, aryl and heteroaryl.

In specific embodiments of the present invention of the square supramolecular metal coordination grid of the formula (I), R¹ is SR³ in which R³is NH₄⁺, R² is NH₂, Y is CH, m is 1, n is 1 and a is 3.

In specific embodiments of the present invention of the square supramolecular metal coordination grid of the formula (I), R¹ is SR³ in which R³ is CH₂CH₃, R² is NH₂, Y is CH, m is 1, n is 1 and a is 3.

In specific embodiments of the present invention of the square supramolecular metal coordination grid used in the binary information recording medium R¹ is H, R² is NH₂, Y is CH, m is 1, n is 1 and a is 3.

In specific embodiments of the present invention of the square supramolecular metal coordination grid used in the binary information recording medium, R¹ is H, R² is phenyl, Y is CH, m is 1, n is 1 and a is 3.

In specific embodiments of the present invention of the square supramolecular metal coordination grid used in the binary information recording medium, R¹ is H, R² is methyl, Y is CH, m is 1, n is 1 and a is 3.

In specific embodiments of the present invention of the square supramolecular metal coordination grid used in the binary information recording medium R¹ is Cl, R² is NH₂, Y is CH, m is 1, n is 1 and a is 3.

In specific embodiments of the present invention of the square supramolecular metal coordination grid used in the binary information recording medium R¹ is H, R² is NH₂, Y is N, m is 1, n is 1 and a is 3.

Still further, the present invention relates to a binary information recording medium comprising a substrate and a recording medium having a monolayer of a square supramolecular metal coordination grid of the formula (I) deposited on the substrate, in which the square supramolecular metal coordination grid has an oxidized state and a reduced state. The oxidized state and the reduced state together correspond to binary ‘on’ or ‘off’ condition.

In embodiments of the present invention, the substrate is selected from the group consisting of gold, graphite, titanium dioxide, silicon dioxide and glass.

In embodiments of the present invention, the square supramolecular metal coordination grid is oxidized by a chemical oxidant or a voltage.

In more specific embodiments of the present invention, the chemical oxidant is selected from the group consisting of chlorine, bromine, hypochlorite, cerium (IV), NOBF₄ and persulfate.

In more specific embodiments of the present invention, the voltage is in the range from 0 to 2 V.

The present invention also relates to a method of forming a binary information recording medium comprising the steps of providing a substrate, and depositing a monolayer of a square supramolecular metal coordination grid of the formula (I), in which the square supramolecular metal coordination grid has an oxidized state and a reduced state. The oxidized state and the reduced state together correspond to binary ‘on’ or ‘off’ conditions.

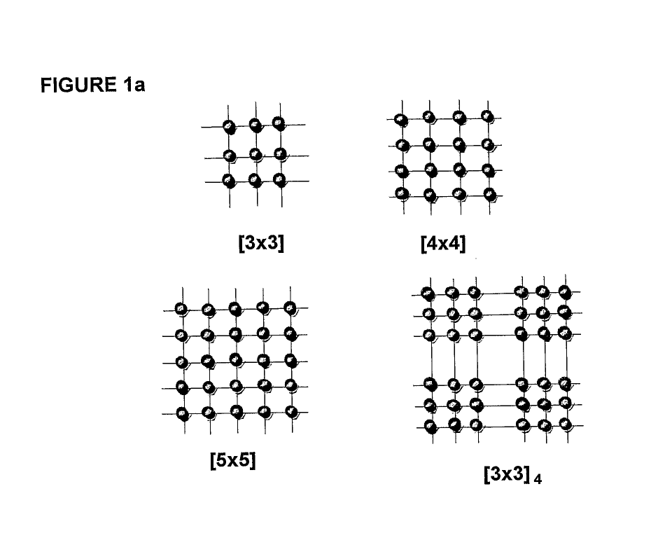

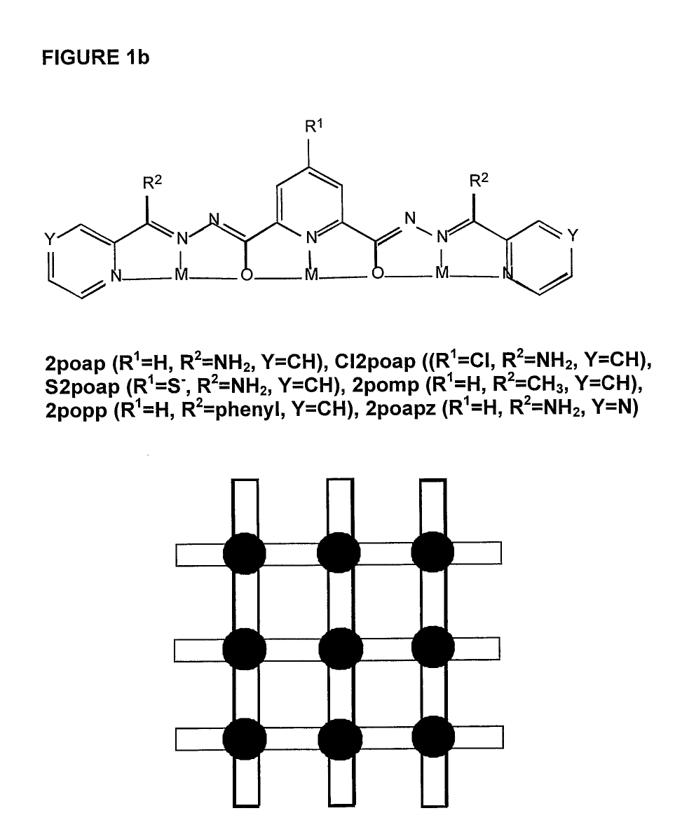

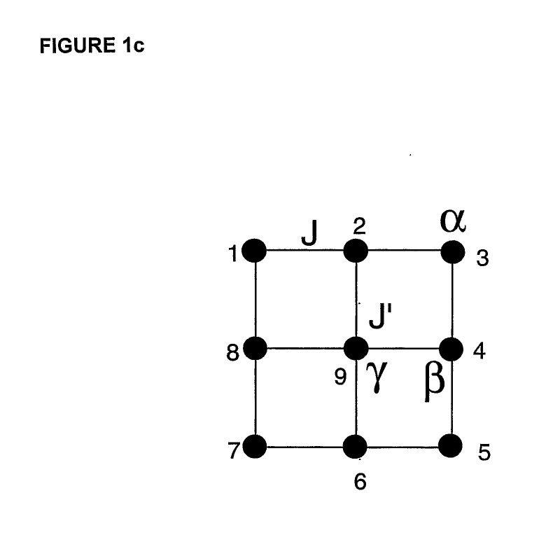

It has been found by the present inventors that a class of molecular coordination compounds has electrochemical properties which are useful in a binary information recording medium. More particularly, the molecular coordination compounds are square supramolecular metal coordination grids which are grid-like arrays containing closely spaced transition metal ions such as [a×a], and [b×b]₄, in which a is 3, 4, 5, and b is 3 (FIG. 1a).

The supramolecular metal coordination grids can be synthesized, for instance, by reacting members of a class of “polytopic” ligands with manganese salts. In one embodiment of the present invention, the ligands are members of a general class based on pyridine-2,6-dicarboxylic acid dihydrazide and its derivatives. As can be seen in FIG. 1b, tritopic ligands with a 2,6-pyridine-dihydrazone core react with transition metal salts such as Mn(II), Fe(II), Fe(III), Co(II), Ni(II) and Cu(II) in a high yield self-assembly process to form nona-nuclear, alkoxide bridged [3×3] grid complexes as a major class.¹⁻⁸ Other coordination modes with ligands of this type involve the formation of self-assembled octanuclear alkoxide bridged ‘pin-wheel’ grid-based clusters in the case of copper(II),⁹ diazine (N₂) bridged systems in a series of trinuclear copper(II) complexes,^{10,11} and a novel Cu₃₆ cluster involving an extended ‘penta-topic’ dioxime ligand.¹² The present inventors have found that intramolecular anti-ferromagnetic exchange prevails in the [3×3] grid complexes in most cases, except copper(II) where dominant intramolecular ferromagnetic exchange is observed in all examples. This also occurs in the octanuclear Cu(II)₈ complexes. The Mn(II)₉ complexes are a particularly interesting class, with S=5/2 ground states, resulting from intramolecular anti-ferromagnetic exchange, and an exchange mechanism which is dominated by the eight Mn(II) atoms in the outer ring (FIG. 1c, J>>J′). The present inventors have found that the [3×3] ‘magnetic’ grid complexes in this class are rare, and other non-magnetic [3×3] examples are limited to a Ag(I)₉ pyridazine bridged grid.¹³ Recent reports in the literature have indicated that expanded, e.g. [4×4]¹⁴ and [4×(2×2)] Pb(II)₁₆¹⁵ grid architectures can be produced with bridging pyrimidine ligands.

The present invention relates to a series of [3×3] Mn(II)₉, anti-ferromagnetically coupled, alkoxide bridged, square grid complexes, derived from a group of ‘tritopic’ dihydrazide ligands. The outer ring of eight Mn(II) centers in the grids is isolated magnetically from the central Mn(II) ion, leading to an S=0 ground state for the ring, and an S=5/2 ground state overall in each case. Exchange in the Mn(II)₈ ring can be represented by a 1D chain exchange model. Rich electrochemistry displayed by these systems has lead to the production of Mn(II)/Mn(III) mixed oxidation state grids by both electrochemical and chemical means.

The present invention more particularly relates to square supramolecular metal coordination grids of the following: [Mn₉(2poap)₆](C₂N₃)₆.10H₂O (1), [Mn₉(2poap)₆]₂[Mn(NCS)₄(H₂O)]₂(NCS)₈.10H₂O (2), [Mn₉(2poapz)₆](NO₃)₆.14.5H₂O (3), [Mn₉(2popp)₆](NO₃)₆.12H₂O (4), [Mn₉(2pomp)₆](MnCl₄)₂Cl₂.2CH₃OH.7H₂O (5), [Mn₉(Cl2poap)₆](ClO₄)₉.7H₂O (6), [Mn₉(Cl2poap)₆](ClO₄)₉.10H₂O (7), [Mn₉(Cl2poap)₆](ClO₄)₆.10H₂O (8), [Mn₉(Cl2poap)₆](ClO₄)₉.6H₂O (9), [Mn₉(2poap)₆](ClO₄)₆.18H₂O (10), [Mn₉(2poapz)₆](ClO₄)₆.10.5H₂O (11) and [Mn₉(S2poap)₆](ClO₄)₁₀.12H₂O (12), [Mn₉(M2poap)₆](ClO₄)₆.22H₂O (13) and [Mn₉(2poap-2H)₆](ClO₄)₁₀.10H₂O (14) [Mn₉(EtS2poap-2H)₆](PF₆)₆.10H₂O (15). The ligands are identified in FIG. 1b, according to formula (II).

It has been found by the present inventors that compound 1 crystallized in the tetragonal system, space group P4₂/n, with a=21.568(1) Å, c=16.275(1) Å, and Z=2. Compound 2 crystallized in the triclinic system, space group Pi, with a=25.043(1) Å, b=27.413(1) Å, c=27.538(2) Å, α=91.586(2)°, β=113.9200(9)°, γ=111.9470(8)°, and Z=2. Compound 3 crystallized in the triclinic system, space group Pi, with a=18.1578(12) Å, b=18.2887(12) Å, c=26.764(2) Å, α=105.7880(12)°, β=101.547(2)°, γ=91.1250(11)°, and Z=2. Compound 4 crystallized in the tetragonal system, space group P4₁2₁2, with a=20.279(1) Å, c=54.873(6) Å, and Z=4. Compound 5 crystallized in the tetragonal system, space group I-4, with a=18.2700(2) Å, c=26.753(2) Å, and Z=2. Compound 6 crystallized in the triclinic system, space group Pi, with a=19.044(2) Å, b=19.457(2) Å, c=23.978(3) Å, α=84.518(3)°, β=81.227(3)°, γ=60.954(2)°, and Z=2.

The present invention also relates to square supramolecular metal coordination grids of the following: [Mn₉(2poap-2H)₆](NO₃)₆.14H₂O (16), [Mn₉(2poap-2H)₆](NO₃)₁₀.25H₂O (17), [Mn₉(Cl2poap-2H)₆](ClO₄)₆.18H₂O (18), [Mn₉(Cl2poap-2H)₆]-(ClO₄)₉.14H₂O.3CH₃CN (19), [Mn₉(Cl2poap-2H)₆](ClO₄)₉.14H₂O.3CH₃CN (20) and [Mn₉(EtS2poap-2H)₆](CF₃SO₃)₆ (21).

The coordination compartments within the [3×3] grid structures formed by these tritopic ligands (FIG. 1c), are comprised of three different donor groupings; corner (α) (cis-N₄O₂), side (β) (mer-N₃O₃) and centre (γ) (trans-N₂O₄) (vide infra). These differing coordination environments clearly lead to different properties at these metal ion sites, which is manifested in terms of e.g. differing redox characteristics, and possibly differing spin ground state situations, depending on the identity of the metal ion, and may even be useful for selective site occupancy in mixed metal systems. The cobalt chemistry of grids with ligands in this class has shown that exposure to air can lead to mixed oxidation state Co(II)/Co(III) systems. This is also possible for the Mn(II)₉ complexes, although reactions in air have not yet indicated any Mn(II) oxidation in general synthesis. Electrochemical studies however have shown clearly defined groups of redox waves in cyclic voltammetry, corresponding to oxidation of Mn(II) to Mn(III), within an easily accessible voltage range (0.5-1.5 V, vs. SSCE), with a four-electron wave at E_{1/2}=0.61 V, and four one-electron waves in the range E_{1/2}=0.92-1.53 V for the complex [Mn₉(2poap)₆](ClO₄)₆.18H₂O (10)¹. In embodiments of the present invention, Mn(II)₉ grid complexes within this class, with various ligands, and the effect of these ligands on structural, magnetic and redox properties of the grid systems are examined. In yet other embodiments of the present invention, the ligands have been functionalized with S-groups at the central 4-pyridine ring positions (e.g. R=S⁻, S—CH₂COOH, S—CH₂Ph, S—CH₃, S—CH₂CH₃ etc.) which has produced Mn(II)₉ grids with soft sites exposed on both surfaces of the grid.

The present inventors have found that supramolecular metal coordination grids in which R¹ is Cl or S⁻, R² is NH₂, Y is CH, and X is ClO₄⁻ can be attached to the surface of a substrate and arranged in a monolayer assembly such that they are within 2-3 nm of each other. The substrate used is gold¹⁶ but may be graphite, titanium dioxide, silicon dioxide or glass. It has been discovered by the present inventors that the substituent at R¹ is responsible for attachment of the supramolecular metal coordination grids to the gold surface of the substrate, and are suitably arranged to provide good contact. The substituents at R¹ may be sulfide, thioether, chloride, bromide, carboxylate, or any other suitable groups which has an affinity for the substrate. For instance, the gold surface may be a gold covered compact disk or a similar substrate. The substrate may also be mica covered with gold. The present inventors have found that the attachment of the supramolecular metal coordination grid on the substrate can be detected by surface imaging techniques such as Scanning Tunneling Microscopy (STM), Atomic Force Microscopy (AFM), or any other suitable techniques.

In an example of the present invention, the compounds [Mn₉(Cl2poap)₆](ClO₄)₆.10H₂O (8), [Mn₉(2poap)₆](ClO₄)₆.18H₂O (10) [Mn₉(S2poap)₆](ClO₄)₁₀.12H₂O (12), [Mn₉(M2poap)₆](ClO₄)₆.22H₂O (13) and [Mn₉(EtS2poap-2H)₆](PF₆)₆.10H₂O (15) have shown electrochemical responses in solution such as in the solvent, acetonitrile, in a voltage in the range of 0.5 to 1.6 V (versus a Ag/AgCl reference electrode, using platinum electrodes), with four electrons removed in a single reversible event at a potential of <1V, followed by four more electrons in four separate, reversible one electron events, up to 1.6V. The first four electrons are removed from manganese atoms at the corners of the grid. The remaining electrons are removed from manganese atoms on the side of the grid.

In an alternative example of the present invention, a gold working electrode is immersed in an acetonitrile solution of a supramolecuar metal coordination grid in which the metal used is manganese. The electrode is then removed and thoroughly rinsed with solvent. From the electrochemical measurements, the present inventors have found that the supramolecular metal coordination grids remain attached to the surface of the electrode as indicated by current/voltage responses in which the voltage range used is between 0.5 to 1.6 V.

The present inventors have also found that chemical oxidants can be used to oxidize the supramolecular metal coordination grid to produce isolable and stable oxidized grids. The oxidants which can be used include chlorine, bromine, hypochlorite, cerium (IV), NOBF₄, and persulfate. In an example of the present invention, the un-oxidized manganese grids have red-orange colors and have very little absorbance in the spectral range of 500 to 1200 nm. The grids begin to change color on oxidation, which is accompanied by the appearance of intense absorption bands at ˜1000 nm and ˜700 nm associated with charge transfer transitions. The intensity of the charge transfer bands diminishes when a reducing agent such as ascorbate is added. When excess reducing agent is added the bands disappear reproducing the same spectrum as the starting material. The band at 1000 nm is assigned to a metal/ligand charge transfer. The band at 700 nm is assigned to a metal to metal charge transfer (MMCT). The MMCT band is associated with the transfer of an electron between β and α sites in the grid (FIG. 1c). Irradiation of the oxidized grid at 700 nm causes a shift in the position of the electrons in the outer ring of eight metal centers from side Mn(II) centers to corner Mn(III) centers. The present inventors have found that oxidation of the manganese grid leads to a significant change in bulk magnetic properties.

The present inventors have found the use of a ‘bottom up’ approach to nanometer scale molecules with device potential relies heavily on molecular design, particularly of a ligand. With the appropriate coordination information encoded into the ligand itself, self-assembly has been shown to be very successful in generating novel polynuclear assemblies with ordered, and predictable, arrays of metal ions in close proximity. Ligands based on the picolinic dihydrazide central core have been particularly successful in this regard, as they bring together nine metal ions, e.g. Mn(II), in close proximity, bridged by small alkoxide oxygen atoms, which ensure that electronic and magnetic communication occurs between the metal centers. Electronic ‘multi-stability’ has been demonstrated, and a sulfur-derivatized grid has been applied to a gold surface.

It has been found that a monolayer of the supramolecular metal coordination grid molecules can be created on a gold surface, with individual molecular dimensions of ˜2.6×2.6 nm,¹⁶ with a surface coverage in the range 10-15*10¹² molecules per cm². If one bit of data were encoded per molecule, this translates to 10-15 TB/cm². Further, if a monolayer of the supramolecular metal coordination grid molecules were placed on the gold surface of for example a gold covered CD, this would translate to 1000-1500 TB per CD if all molecules were encoded with information. Still further, if individual molecules are encoded to a different extent based on the different voltages required to remove electrons, and the number of electrons involved in each step, then each molecule represents a site for multi-bit data storage, thus increasing data capacity.

As demonstrated with the electrochemical studies, successive oxidation and reduction of the Mn(II)₉ grid corresponds to the binary ‘on’ or ‘off’ condition. Due to the functional bistability, and multistability of grids of this type, these grids act as molecular ‘switches’ and thus are useful in storing information. The control over metal ion site oxidation state within a grid motif presents a model system to test the encoding concept based on “quantum dot cellular automata” (QCA), in which the molecules are structured charge containers, which can exist in degenerate states as a result of internal electron redistribution. Combinations of such subunits in close proximity, with appropriate electrostatic communication, could lead to the “on” and off” states.

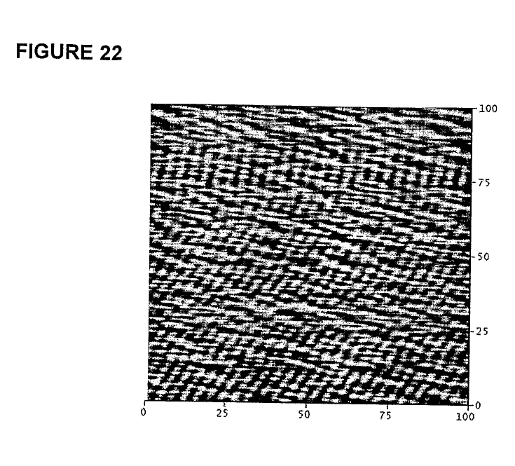

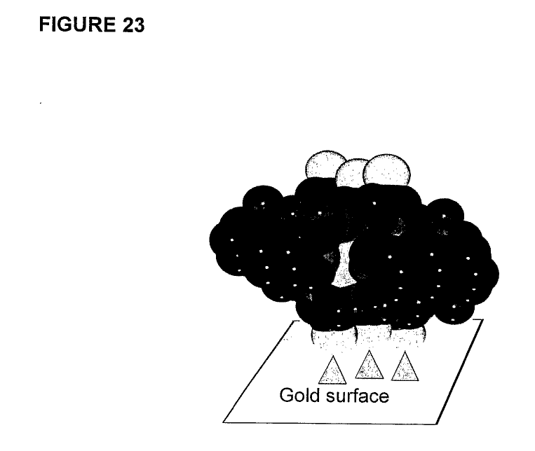

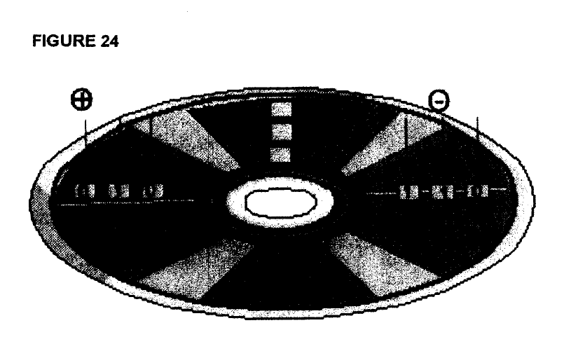

As shown in FIG. 22, if a charged AFM tip can contact a supramolecular metal coordination grid, it can be selectively oxidized, using appropriate applied voltages in a write cycle, as the tip travels over the monolayer surface of the substrate. In a reverse write (i.e. read) cycle, appropriate negative voltages would be applied. Stored information would be recorded in both write and read cycles by current flow.

The following non-limiting examples are illustrative of the present invention:

### EXAMPLES

Materials and Methods

Infrared spectra were recorded as Nujol mulls using a Mattson Polaris FT-IR instrument. Mass spectra were obtained with VG Micromass 7070HS (EI) and HP1100MSD (LCMS) spectrometers. UV/Vis spectra were obtained with a Varian/Cary 5E spectrometer. Nmr spectra were recorded using a GE 300 MHz instrument. Micro-analyses were carried out by Canadian Microanalytical Service, Delta, Canada. Variable temperature magnetic data (2-300K) were obtained using a Quantum Design MPMS5S SQUID magnetometer with field strengths in the range of 0.1 to 5.0 T. Samples were prepared in gelatin capsules or aluminum pans, and mounted inside straws for attachment to the sample transport rod. Background corrections for the sample holder assembly and diamagnetic components of the complexes were applied. Electrochemical studies were carried out with a BAS 100B electrochemistry system, with a Pt working electrode, Pt counter electrode, and SSCE and Ag/AgCl reference electrodes. Differential pulse voltammetry was carried out at a 20 mV/s scan rate (50 mV pulse amplitude, 50 ms pulse width) in an oxidative sweep. Bulk electrolytic oxidation was carried out using a Pt mesh working electrode, a Pt mesh counter electrode, and a Ag/AgCl reference electrode, with a HP6215A power supply connected to a high impedance voltmeter. STM images were acquired with a Digital Instrument Nanoscope IV controller in combination with an STM base. Electrochemically etched tungsten tips were used.

### Example 1

### Synthesis of Ligands

(a) Preparation of the ligand 2popp: 2-benzoyl pyridine (10.0 g, 0.055 mol) was dissolved in methanol (250 mL). Pyridine-2,6-dihydrazide (5.00 g, 0.026 mol) was added and the mixture refluxed overnight. The white solid formed was collected by filtration and washed with methanol and ether and air dried (Yield 12.3 g, 92%). M.p. 275-278° C. Mass spectrum (LCMS; chloroform) (M/z) 526.5 (M+H). IR (cm⁻¹) 3294 (ν OH, NH), 1695, 1558 (ν CO, CN), 997 (ν pyr). Anal. Calcd. For C₃₁H₂₃N₇O₂: C, 70.85; H, 4.41; N, 18.66. Found: C, 70.73; H, 4.46; N, 18.88. 2pomp was obtained in a similar manner by reacting pyridine-2,6-dihydrazide with 2-acetyl pyridine in methanol (Yield 99%). M.p. 313-315° C. Mass spectrum (M/z); 401 (M+.), 386 (M-CH₃), 323 (M-C₅H₄N), 240, 224, 182, 134, 106, 78. IR (ν, cm⁻¹) 3350 (NH), 1704, 1695 (CO), 992 (py). NMR (DMSO-d6, ppm) 2.1 (s), 2.6 (s, CH₃), 7-9 (m, aromatic ring), 11.0 (s), 11.5 (s, NH). Anal. Calc. for C₂₁H₁₉N₇O₂; C, 62.83; H, 4.77; N, 24.42. Found; C, 62.47; H, 4.77; N, 24.67.

The synthesis of 2poap has already been reported,¹ and it is obtained by reaction of pyridine-2,6-dihydrazone with the methyl ester of imino-2-pyridine carboxylic acid. 2poapz and Cl2poap are obtained in a similar manner, by reacting pyridine-2,6-dihydrazone with the methyl ester of imino-2-pyrazine carboxylic acid, and 4-chloro-pyridine-2,6-dihydrazone with the methyl ester of imino-2-pyridine carboxylic acid respectively.^{5,6} S2poap is prepared from the reaction of ammonium 4-thiolato-2,6-pyridine dihydrazone with the methyl ester of imino-2-picolinic acid. The dihydrazone is prepared from ammonium 2,6-dicarbethoxypyridine-4-thiolate.¹⁷ M2poap was prepared from 4-methoxy-2,6-pyridine dihydrazone as previously described.⁷

(b) Preparation of the ligand EtS2poap: 2-cyanopyridine (0.51 g, 0.0049 mole) was added to sodium methoxide (0.001 mole) in methanol and stirred for 2 hr. Acetic acid was added to neutralize the solution. 4-ethylthio-2,6-pyridine dihydrazone (0.45 g, 0.0017 mol) was added, and the mixture stirred for 2 days. A pale yellow powder was collected (Yield 2.1 g, 92%) (Mp. 240-244° C.) (Mass spectrum; (M+1) 464.1; LCMS).

### Example 2

### Syntheses of Complexes

(a) Preparation of the [Mn₉(2popp)₆](NO₃)₆.12H₂O (4): Mn(NO₃)₂.6H₂O (0.17 g, 0.59 mmol) was dissolved in methanol (20 mL). 2popp (0.10 g, 0.19 mmol) was added along with chloroform (10 mL) and the mixture warmed. The ligand dissolved forming a pale orange coloured solution. Red crystals formed after two weeks (Yield 35%), which were suitable for structural determination. Anal. Calcd. for (C₃₁H₂₁N₇O₂)₆Mn₉(NO₃)₆.(H₂O)₁₂. C, 52.89; H, 3.58; N, 15.90. Found. C, 52.89; H, 3.37; N, 15.71.

(b) Preparation of the [Mn₉(2pomp)₆](MnCl₄)₂Cl₂.2CH₃OH.7H₂O (5): 2pomp (0.20 g, 0.50 mmol) was added to a solution of MnCl₂.6H₂O (0.40 g, 2.0 mmol) in methanol (10 mL) and the mixture stirred with warming. The ligand quickly dissolved to give a pale colored solution, and the subsequent formation of a bright yellow precipitate. Mn(CH₃COO)₃.3H₂O (0.2 g, 0.75 mmol) was added, resulting in a clear, deep red solution. Stirring and heating were continued for 1 hr, the solution filtered and then allowed to evaporate slowly at room temperature. Deep red prismatic crystals suitable for structural analysis were formed after several weeks (Yield 35%). Mn(CH₃COO)₃.3H₂O simply acted as a source of weak base (acetate) in the reaction, facilitating proton loss from the ligands. Anal. Calcd. for (C₂₁H₁₇N₇O₂)₆ Mn₉(MnCl₄)₂Cl₂(CH₃OH)₂(H₂O)₇. C, 43.36; H, 3.52; N, 16.59. Found. C, 43.40; H, 2.99; N, 16.78.

(c) Preparation of [Mn₉(2poap)₆](C₂N₃)₆.10H₂O (1), [Mn₉(2poap)₆]₂[Mn(NCS)₄(H₂O)]₂(NCS)₈.10H₂O (2), [Mn₉(2poapz)₆](NO₃)₆.14.5H₂O (3), and [Mn₉(2poapz)₆](ClO₄)₆.10.5H₂O (11): The above complexes were prepared under similar conditions to 4 using the appropriate ligand and Mn(II) salt in methanol, methanol/acetonitrile or acetonitrile/water mixtures (Yields>60%). For 1 and 2 the ligand and Mn(NO₃)₂.6H₂O were reacted in the normal way, and then solutions of Na(N(CN)₂) and NH₄NCS were added respectively. All structural samples were stored under mother liquor prior to structural analysis because of crystal instability resulting from solvent loss on exposure to air. Analytical data: [Mn₉(2poap)₆](C₂N₃)₆.10H₂O (1). Anal. Calcd. for (C₁₉H₁₅N₉O₂)₆Mn₉(C₂N₃)₆.(H₂O)₁₀. C, 43.50; H, 3.19; N, 28.99. Found. C, 43.68; H, 3.04; N, 29.14.[Mn₉(2poap)₆]₂[Mn(NCS)₄(H₂O)]₂(NCS)₈.10H₂O (2). Anal. Calcd. for (C₁₉H₁₅N₉O₂)₁₂Mn₁₈(Mn(H₂O)(NCS)₄)₂(NCS)₈.(H₂O)₁₀. C, 41.50; H, 2.91; N, 24.60. Found. C, 41.26; H, 2.72; N, 25.12. [Mn₉(2poapz)₆](NO₃)₆.14.5H₂O (3). Anal. Calcd. for (C₁₇H₁₃N₁₁O₂)₆Mn₉(NO₃)₆.(H₂O)_{14.5}. C, 34.49; H, 3.02; N, 28.42. Found. C, 34.47; H, 2.62; N, 28.85.⁵ [Mn₉(2poapz)₆](ClO₄)₆.10.5H₂O (11). Anal. Calcd. for (C₁₇H₁₃N₁₁O₂)₆Mn₉(ClO₄)₆.(H₂O)_{10.5}. C, 33.11; H, 2.68; N, 24.98. Found. C, 33.13; H, 2.39; N, 24.99.

Preparation of the [Mn₉(S2poap)₆](ClO₄)₁₀.12H₂O (12): S2poap was added to a solution of an excess of Mn(ClO₄)₂.6H₂O in acetonitrile forming a red solution, which produced a red crystalline product after concentration to a small volume and addition of ether (Yield 77%). The crystals were not suitable for a structural analysis. Anal. Calcd. for (C₁₉H₁₅N₉O₂S)₆Mn₉(ClO₄)₁₀(H₂O)₁₂; C, 31.80; H, 2.67; N, 17.57. Found: C, 31.67; H, 2.64; N, 17.54.

Compounds [Mn₉(Cl2poap)₆](ClO₄)₆.10H₂O (8), and [Mn₉(2poap)₆](ClO₄)₆.18H₂O (10) were synthesized according to previously published procedures.^{1,5}

Preparation of [Mn₉(M2poap)₆](ClO₄)₆.22H₂O (13): M2poap (0.43 g, 1.0 mmol) was added to a solution of Mn(ClO₄)₂.6H₂O (1.1 g, 3.0 mmol) in MeOH/CH₃CN/H₂O (10 mL/10 mL/3 mL) with warming to form an orange solution. Orange crystals were produced on standing at room temperature for an extended period (Yield 70%). Anal. Calcd. for (C₂₀H₁₇N₉O₃)₆Mn₉(ClO₄)6(H₂O)₂₂; C, 35.05; H, 3.67; N, 18.39. Found: C, 34.87; H, 2.94; N, 18.30.

Preparation of [Mn₉(EtS2poap)₆](PF₆)₆.10H₂O (15): EtS2poap (0.10 g, 0.22 mmol) was added to a solution of Mn(CF₃SO₃)₂ (0.55 g, 1.6 mmol) in MeOH/CH₃CN/H₂O (6 mL/6 mL/3 mL) with warming to form a red-orange solution. NH₄PF₆ (excess) was added, the mixture stirred and filtered, and the solution allowed to stand. Orange crystals were produced at room temperature over an extended period (Yield 70%).

Preparation of [Mn₉(2poap-2H)₆](NO₃)₆.14H₂O (16): 2poap (0.50 g, 1.24 mmol) was added to a solution of Mn(NO₃)₂.6H₂O (0.86 g, 3.0 mmol) in MeOH/H₂O (50 mL/50 mL/) with stirring and warming. NH₄OH (aq) (20%) was added dropwise with stirring until the pH reached 6.0, with the formation of an orange-brown solution. The volume of the solution was reduced under vacuum until crystals began to form, and the mixture was allowed to stand at room temperature for several days. A red-orange crystalline product formed, from which crystals were selected for structural analysis. (Yield 90%). Anal. Calcd. for (C₁₉H₁₅N₉O₂)₆Mn₉(NO₃)₆(H₂O)₁₄; C, 38.82; H, 3.37; N, 28.83%. Found: C, 38.82; H, 2.69; N, 23.82%.

(d) Chemically oxidized manganese grids [Mn₉(Cl2poap)₆](ClO₄)₉.7H₂O (6), [Mn₉(Cl2poap)₆](ClO₄)₉.10H₂O (7)

[Mn₉(Cl2poap)₆](ClO₄)₆.10H₂O (8) (0.080 g, 0.020 mmol) was dissolved in acetonitrile (20 mL) to give a deep red-orange solution. NaClO₄ (0.020 g) dissolved in water (3 mL) was added, followed by saturated chlorine water (12 mL). The solution became brown after several hours and the solvent was allowed to evaporate slowly at room temperature. Dark brown crystals of 6 suitable for structural study were deposited after several days in almost quantitative yield. They were kept under mother liquor prior to structural analysis. Anal. Calcd. for (C₁₉H₁₄N₉O₂Cl)₆Mn₉(ClO₄)₉.(H₂O)₇ (6). C, 33.15; H, 2.39; N, 18.31. Found. C, 32.68; H, 2.20; N, 18.33. 7 was prepared in a similar manner using saturated Br₂(aq), and also obtained as dark brown crystals. Anal. Calcd. for (C₁₉H₁₄N₉O₂Cl)₆Mn₉(ClO₄)₉.(H₂O)₁₀ (7). C, 32.76; H, 2.49; N, 18.10. Found. C, 32.68; H, 2.20; N, 18.06.

### Example 3

### Electrochemical Oxidation

Bulk electrochemical oxidation was carried out in a three electrode cell comprising a platinum mesh working electrode (anode), platinum mesh counter electrode (cathode) in a separate compartment separated by a glass frit, and saturated Ag/AgCl reference electrode. [Mn₉(Cl2poap)](ClO₄)₆.10H₂O (8) (0.280 g) and tetraethyl ammonium perchlorate (0.690 g) were dissolved in a mixture of acetonitrile (100 mL) and water (100 mL), forming a clear orange solution. A potential of ˜15V was applied across the electrodes using a HP 6215A power supply, and 1 mL of 70% HClO₄(aq) was added to the counter electrode compartment. The potential was then adjusted to 1.8±0.2 V with respect to the Ag/AgCl reference electrode and electrolysis was continued for seven hours with the formation of a brown solution, and evolution of hydrogen gas at the cathode. The solution was filtered and its volume reduced by evaporation under reduced pressure, with the formation of a dark brown crystalline solid, which was isolated by filtration and washing with ether (Yield 70%). Anal. Calcd. for (C₁₉H₁₄N₉O₂Cl)₆Mn₉(ClO₄)₉.(H₂O)₆ (9). C, 33.29; H, 2.36; N, 18.39. Found. C, 33.32; H, 2.44; N, 18.38.

### [Mn₉(2poap-2H)₆](ClO₄)₁₀.10H₂O (14)

[Mn₉(2poap-2H)₆](ClO₄)₆.18H₂O (10) (480 mg, 0.13 mmol) and tetraethylammonium perchlorate (550 mg) were dissolved in a mixture of 80 mL acetonitrile and 50 mL water, forming a clear orange-red solution. The solution was placed in an electrolytic cell comprising a platinum mesh anode, and a platinum wire cathode contained in a fritted sleeve. The electrodes were charged to +20 V, and 5 drops of 70% perchloric acid added to the cathode compartment. After ca. 4 hours, the solution became very dark brown. It was concentrated by evaporation under reduced pressure and chilled in a freezer. A dark brown solid precipitated, which was isolated by suction filtration, washed with diethyl ether, and air-dried. Yield: 210 mg (39%).

Recrystallization from acetonitrile produced dark brown crystals suitable for structural analysis. Anal. Calcd for [(C₁₉H₁₅N₉O₂)₆Mn₉](ClO₄)₁₀.10H₂O (14): C, 33.60; H, 2.72; N, 18.58%. Found: C, 33.55; H, 2.58; N, 18.42%. Selected IR data (Nujol mull, cm⁻¹): 1071 (ν ClO₄⁻).

### [Mn₉(2poap-2H)₆](NO₃)₁₀.25H₂O (17)

[Mn₉(2poap-2H)₆](NO₃)₆.14H₂O (16) (0.20 g, 0.056 mmol) and potassium nitrate (2.03 g, 20 mmol) were dissolved in a mixture of 125 mL acetonitrile and 75 mL water, forming a clear orange solution (0.1 M in KNO₃). The solution was placed in an electrolytic cell, and the electrodes were charged to +1 V versus saturated Ag/AgCl reference electrode. There were 10 drops of 10% nitric acid added to the counter electrode, and the potential was readjusted to +2.0±0.1 V. The electrolysis proceeded for 27 h, at which time no discernible change in current was observed. The very dark brown solution was concentrated by evaporation under reduced pressure and left to stand. After ca. 8 weeks, dark brown lustrous crystals formed. The crystals were not suitable for structural analysis. Yield 0.070 g (33%). Anal. Calcd for [(C₁₉H₁₅N₉O₂)₆Mn₉](NO₃)₁₀·25H₂O (17): C, 34.46; H, 3.55; N, 22.56%. Found: C, 34.37; H, 3.01; N, 22.54%.

### [Mn₉(Cl2poap-2H)₆](ClO₄)₆.18H₂O (18), [Mn₉(Cl2poap-2H)₆]-(ClO₄)₉.14H₂O.3CH₃CN (19), and [Mn₉(Cl2poap-2H)₆](ClO₄)₉.14H₂O.3CH₃CN (20)

To provide a chemical method for the synthesis of integer oxidation state Mn(II)/Mn(III) grids, samples of [Mn₉(Cl2poap-2H)₆](ClO₄)₆.10H₂O (8) (˜0.01 mmol) and excess NEt₄ClO₄ were dissolved in acetonitrile and treated with elemental Br₂(I) in varying mole ratios (1:1, 5:1, 9:1; (18, 19, 20, respectively). An orange-brown solution resulted for 18, while dark brown solutions were obtained in the other cases. Dark orange crystals were obtained for 18, while dark brown crystalline solids formed for 19 and 20 in almost quantitative yields. Anal. Calcd for [(C₁₉H₁₄N₉O₂Cl)₆Mn₉](ClO₄)₆.18H₂O (18): C, 34.00; H, 2.98; N, 18.79%. Found: C, 34.13; H, 2.59; N, 18.46%. Anal. Calcd for [(C₁₉H₁₄N₉O₂Cl)₆Mn₉](ClO₄)₆.14H₂O.3CH₃CN (19): C, 34.94; H, 2.71; N, 18.26%. Found: C, 33.32; H, 2.35; N, 17.90%. Anal. Calcd for [(C₁₉H₁₄N₉O₂Cl)₆Mn₉]-(ClO₄)₆.14H₂O.3CH₃CN (20): C, 32.94; H, 2.71; N, 18.26%. Found: C, 32.92; H, 2.29; N, 17.93%.

### Example 4

### Crystallographic Data and Refinement of the Structures

The diffraction intensities of an orange-red prismatic crystal of 5 were collected with graphite-monochromatized Mo-Ka X-radiation (rotating anode generator) using a Bruker P4/CCD diffractometer at 193(1) K to a maximum 2θ value of 52.9°. The data were corrected for Lorentz and polarization effects. The structure was solved by direct methods.¹⁸⁻²⁰ All atoms except hydrogens were refined anisotropically. Hydrogen atoms were placed in calculated positions with isotropic thermal parameters set to 20% greater than their bonded partners, and were not refined. Neutral atom scattering factors²¹ and anomalous-dispersion terms^{22,23} were taken from the usual sources. All other calculations were performed with the teXsan²⁴ crystallographic software package. Crystal data collection and structure refinement for 1 (red-brown prisms), 2 (red prisms), 3 (red brown prisms), 4 (red brown prisms), and 6 (dark brown prisms) were carried out in a similar manner using Mo—Kα X-radiation. Abbreviated crystal data for 1-6 are given in Table 1.

### Example 5

### Studies on the Structures

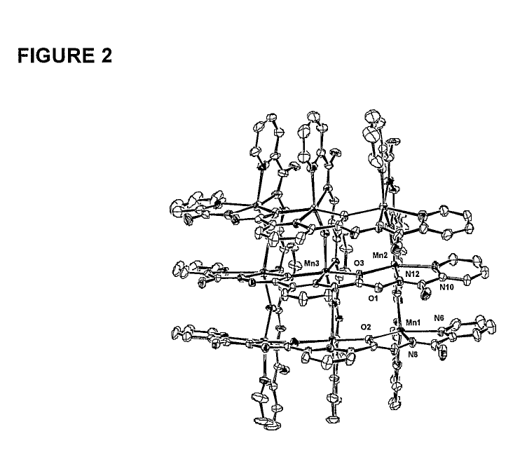

The structure of the cation in 1 is shown in FIG. 2, and important bond distances and angles are listed in Table 2. The tetragonal space group indicates 4-fold symmetry in the cation. The homoleptic grid arrangement involves six roughly parallel heptadentate ligands arranged above and below the [Mn₉(μ-O)₁₂] core, with the nine metal ions bridged by twelve alkoxide oxygen atoms within the core. Mn—Mn distances fall in the range 3.886-3.923 Å, with Mn—O—Mn angles in the range 126.7-126.93°, typical for grids in this class. Due to the symmetry in the grid the distances between corner Mn(II) centers are equal (7.770 Å). The corner Mn(II) centers have cis-MnN₄O₂ coordination environments, the side Mn(II) centers have mer-MnN₃O₃ coordination environments, and the center Mn(II) ion has a trans-MnN₂O₄ coordination environment. The central Mn atom has almost equal Mn—O and Mn—N distances (2.190(4), 2.180(6) Å respectively), the corner Mn centers and the side Mn centers have much longer Mn—N distances to the external pyridine rings (2.319(7), 2.215(2) Å respectively), with shorter remaining Mn—N and Mn—O contacts (2.141-2.296 Å). The long external Mn—N distances are clearly a consequence of the stretching of the ligands over the nona-nuclear core. The pyridine rings are arranged in an approximately parallel fashion with quite short inter-ring separations; 3.5-4.1 Å for the external rings and 3.3-3.7 Å for the central rings. This clearly indicates significant π interactions between the rings, and a stabilizing effect contributing to the self assembly of the grid. The dicyanamide anions show no tendency to influence the stability of the grid, and are present as uncoordinated ions.

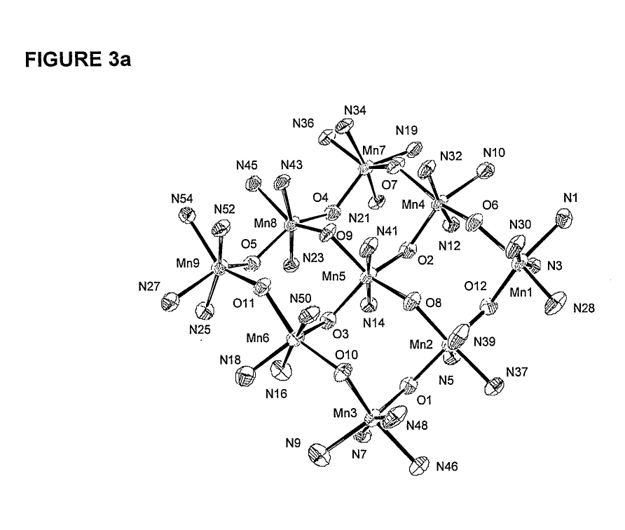

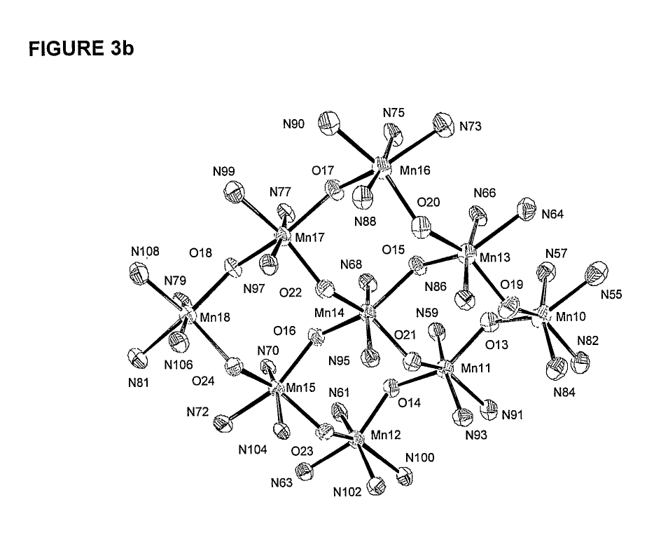

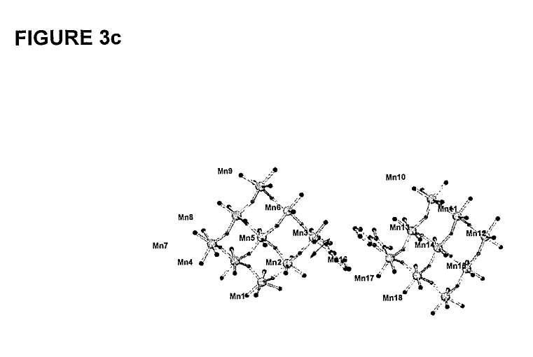

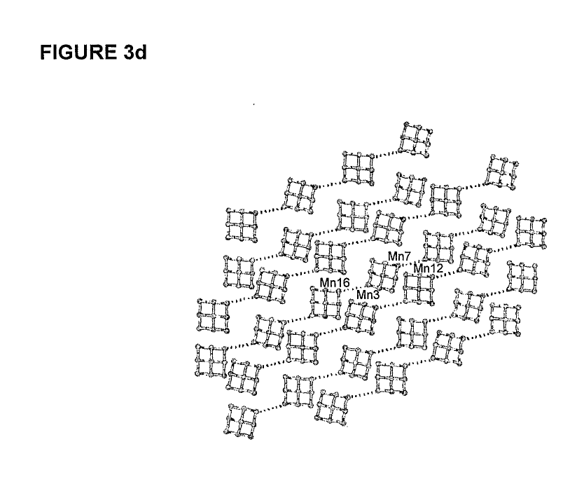

The structure of 2 is comprised of two Mn(II)₉ grids within the asymmetric unit, which are very close together, and linked by π interactions between two pyridine rings at the corners of two adjacent grid cations. The lattice contains many water molecules, five discernable thiocyanate anions and two unusual trigonal-bipyramidal, five-coordinate [Mn(H₂O)(NCS)₄]²-anions. Important bond distances and angles are listed in Table 3. Fully labeled core structures for both Mn₉ cationic grid fragments are shown in FIGS. 3a and 3b. FIG. 3c shows the simplified core structures of the two cations (POVRAY©), and the overlapping pyridine rings connecting Mn(3) and Mn(16), with inter-ring atom contacts falling in the range 3.455-3.960 Å. These short π interactions clearly indicate a way in which the grids can associate, which may lead to inter-grid electronic and magnetic communication. Further examination of the extended structure of 2 shows that Mn(7) and Mn(12) are also connected by a similar π interaction, with cross ring contacts as short as 3.55 Å. An extended structural representation showing Mn(3)-Mn(16) and Mn(7)-Mn(12) contacts is available in FIG. 3d. The grids are effectively connected in associated chains in the xy plane (Mn(3)-Mn(16) 9.069 Å, Mn(7)-Mn(12) 8.907 Å). Mn—Mn distances within each grid fall in the normal range (3.882-4.034 Å), and Mn—O—Mn angles in the range 125.7-131.1.1° The two grid cations resemble closely the structure of the grid in 1, with the same ligand.

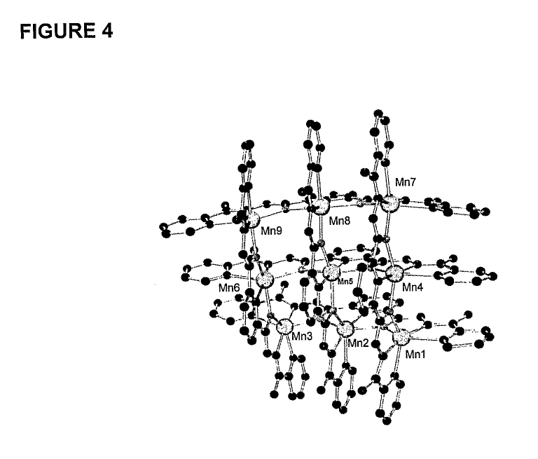

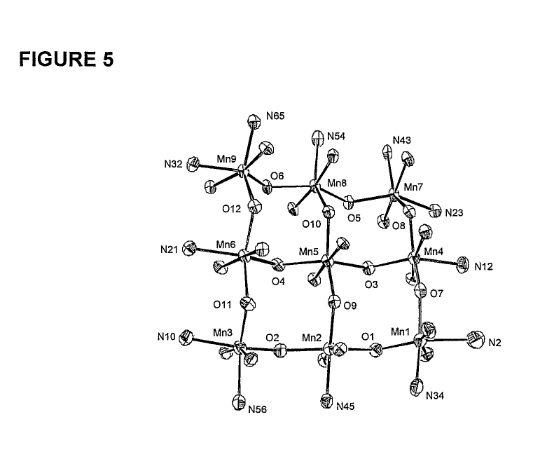

The molecular structure of the cation in 3 is shown in FIG. 4 (POVRAY©), and important bond distances and angles are listed in Table 4. The core structure is shown in FIG. 5, with just the immediate donor atoms. The overall grid structure is very similar to that in 1, and 2. Mn—Mn distances fall in the range 3.902-3.941 Å, with Mn—O—Mn angles in the range 127.0-128.7°. The presence of terminal pyrazine rings leads to somewhat longer external Mn—N distances (2.302-2.502 Å) than those found for 1 and 2, in keeping with the weaker donor character of pyrazine compared with pyridine. The overall core dimensions are essentially the same as those in 1 and 2 (Mn—Mn corner distances 7.722-7.771 Å).

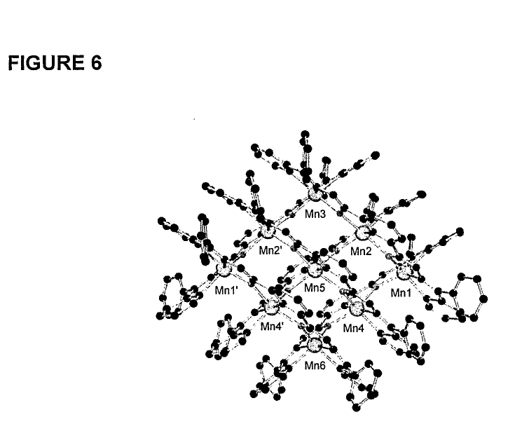

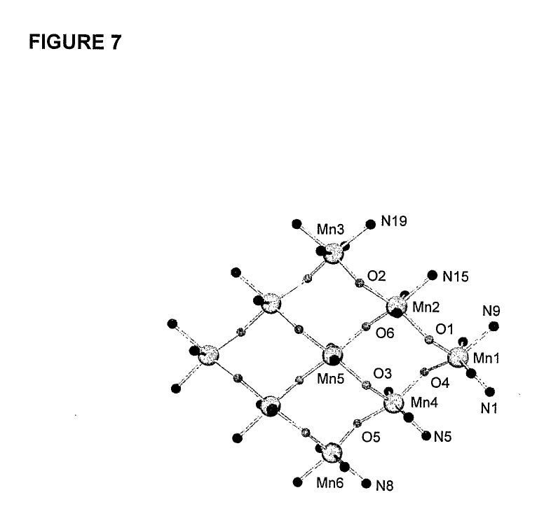

The structure of the cation in 4 is shown in FIG. 6 (POVRAY©), and important bond distances and angles are listed in Table 5. The core structure, showing just the metal ions and ligands, is shown in FIG. 7 (POVRAY©). What is immediately apparent in the structure is the steric crowding at the ends of each 2popp ligand, which has both pyridine and phenyl rings bonded to the terminal carbon of the ligand backbone. The pyridine rings are coordinated in their usual way, with the aromatic rings forming the typical π-stacked arrangement. Inter-ring distances between equivalent ring atoms on pyridine rings bonded to Mn(1) and Mn(4) fall in the range 3.81-3.92 Å, while for Mn(4) and Mn(6) the distances are in the range 3.65-4.20 Å. However the phenyl rings are arranged in a similar stack, but are not as parallel. Equivalent inter-ring distances for phenyl rings close to Mn(1), Mn(4) and Mn(6) are in the ranges 4.05-4.72 Å and 4.00-5.13 Å respectively. Similar inter-ring distances are observed for the Mn(1), Mn(2) and Mn(3) groupings.

The effect of the steric crowding is to exert a major distortion on the grid as a whole, with compression of the ‘square’ along the Mn(3)-Mn(5)-Mn(6) axis forming a diamond shaped grid. Mn(1)-Mn(6) and Mn(1)-Mn(3) distances are normal (7.727 Å and 7.850 Å respectively), but the Mn(3)-Mn(6) distance (9.799 Å) is much shorter than the Mn(1)-Mn(1)′ distance (12.11 Å). This is in sharp contrast to the other Mn₉ systems, which have an approximately square, but twisted core arrangements, and indicates a subtle way of changing the overall grid dimensions. Individual Mn—Mn separations (3.90-3.96 Å) and Mn—O—Mn angles (126.0-128.3°) are normal. It is of interest to note also that Mn-ligand distances in 4 do not exceed 2.3 Å, contrary to what is observed in most other Mn(II)₉ grids.

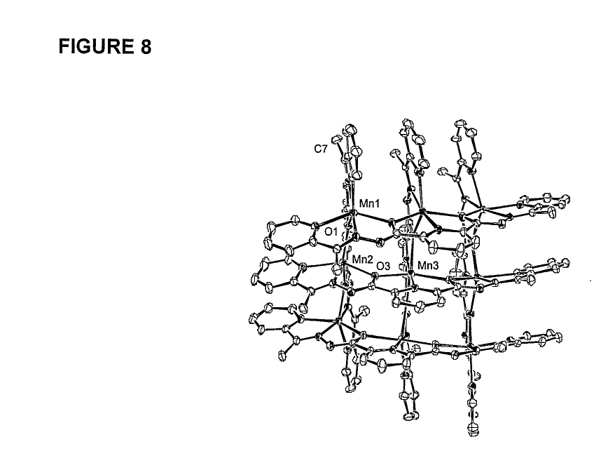

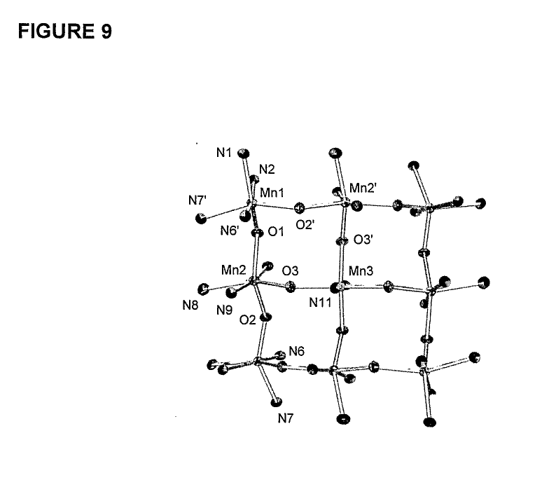

The structure of the cation in 5 is shown in FIG. 8, and important bond distances and angles are listed in Table 6. The structural core showing the metal ions, with the immediate ligand atoms is shown in FIG. 9 (POVRAY©). Mn—Mn distances fall in the range 3.90-3.97 Å, and Mn—O—Mn angles in the range 127.6-128.6°, with a corner to corner metal separation of 7.824 Å. The ligand 2pomp has a methyl group bonded to the terminal carbon of the ligand backbone, and unlike 2popp there is no significant steric effect associated with this group leading to any distortion of the grid. In this respect it behaves like the parent ligand 2poap. Metal-ligand distances are typical for the Mn grids.

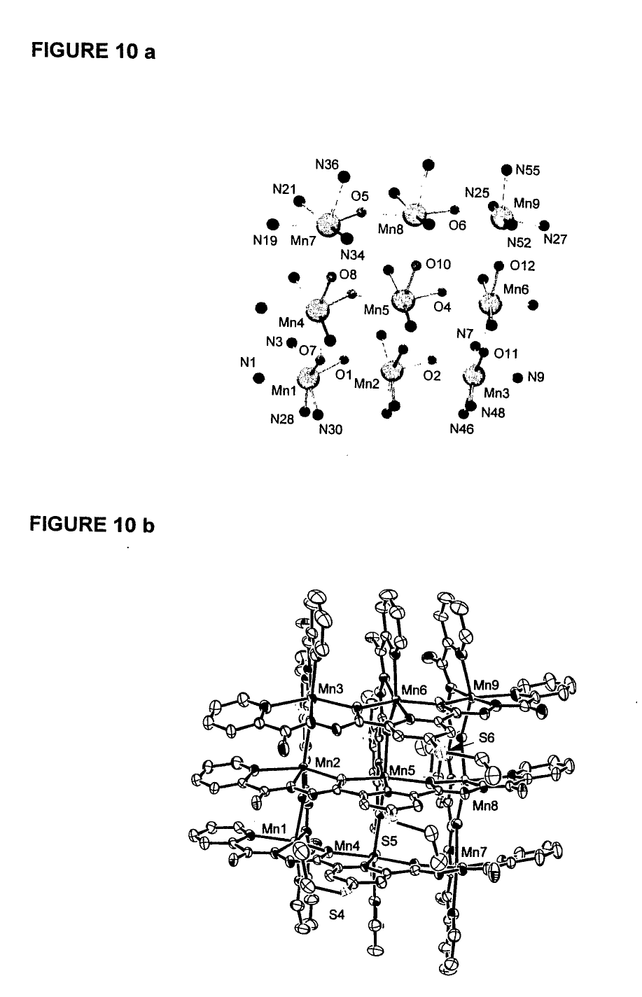

Compound 6 is derived by chemical oxidation of the complex [Mn₉(Cl2poap-2H)₆] (ClO₄)₆.8H₂O (8) with chlorine. The complex formed dark brown needles in high yield, but a weak data set and difficulties with the solution, due in part to disorder in the lattice perchlorates, and with one pyridine ring, bound to Mn(9), which is disordered over two ring positions, led to a less than ideal solution. However the grid is clearly defined, and the number of perchlorate anions in the lattice can be reasonably estimated in agreement with the elemental analysis. The core structure is shown in FIG. 10a (POVRAY©). Adjacent Mn—Mn distances fall in the range 3.87-4.03 Å, and Mn—Mn distances between corner metals fall in the range 7.80-7.99 Å, similar to the other ‘square’ Mn(II)₉ grids. The most relevant comparison grid is 8, which has adjacent Mn—Mn distances in the range 3.886-4.055 Å, and corner Mn—Mn distances of 7.720-8.051 Å, very similar overall dimensions to 6. However close examination of Mn-ligand distances for 6 reveals some rather short contacts to three of the corner metal ions, Mn(1), Mn(3) and Mn(9) (ave. 2.066 Å, 2.055 Å, 2.062 Å respectively), much shorter than would be anticipated for Mn(II) ions, but consistent with Mn(III) centers. The average Mn-L distance of 2.164 Å for Mn(7) shows that this site is mostly Mn(II). Comparable Mn-L distances for the corner manganese sites in 8 are in the range 2.122-2.388 Å with average values of 2.213 Å, 2.210 Å, 2.229 Å and 2.226 Å.

Jahn-Teller distortions would be expected for Mn(1), Mn(3) and Mn(9), but despite two quite short distances in each case (<2 Å), defining such a distortion is not obvious. Metal centers in the grids are in general highly distorted anyway, regardless of the metal and its oxidation state, and this is due in large measure to the balance of metal-ligand donor interactions, and packing constraints of the ligands as they assemble around the core. However the longest axes can be defined as N(1)-Mn(1)-O (1), N(46)-Mn(3)-O(11) and N(55)-Mn(9)-O(12) for the Mn(III) centers, which may be considered as the Jahn-Teller axes. The Mn—O—Mn angles for 6 fall in the range 129.6-135.2°, which is considerably larger than similar angles observed in the parent Mn(II)₉ grid complex (8) (126.4-130.7°). The larger angles are associated with Mn(1), Mn(3) and Mn(9), again an indication that these are the Mn centers which are oxidized. This can be reasonably rationalized in terms of an overall grid dimension that is essentially unchanged compared with the parent complex (8), but with shorter overall bond distances within the outer ring of eight Mn centers involving Mn(1), Mn(3) and Mn(9). The disorder in the structure, and the difficulty of fixing the occupancy of some perchlorates, points to the possibility of different grids within the lattice, in terms of the Mn(II) and Mn(III) site composition. However it is quite clear that at least three Mn centers on average in 6 are in the 3+ oxidation state.

A preliminary structural determination on 14 has shown that all four corner manganese centers have been oxidized to Mn(III), in agreement with the electrochemical studies. The large apparent voltage required for full oxidation in the two electrode cell (˜20 V) clearly indicates significant solution resistance during bulk electrolysis. Higher voltages may be applied for further metal oxidation in bulk electrolysis.

### Example 6

### Studies on the Electrochemcial Properties and Chemical and Electrochemical Oxidation of Mn(II)₉ Grids

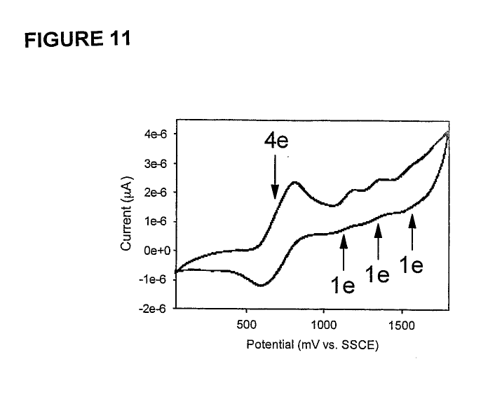

The cyclic voltammetry of an acetonitrile solution of [Mn₉(Cl2poap-2H)₆](ClO₄)₆.8H₂O (8) is shown in FIG. 11. A prominent quasi-reversible wave occurs at E_{1/2}=0.73 V (ΔEₚ=216 mV), which has been shown to correspond to a four electron redox process using controlled potential electrolysis, and assigned to the oxidation of four Mn(II) centers to Mn(III). Three less distinct waves occurring at higher potentials (E_{1/2}=1.16 V (ΔEₚ=116 mV) 1.33 V (ΔEₚ=102 mV) and 1.54 V (ΔEₚ=76 mV)) each correspond to one electron redox process (CPE), and are associated with oxidation of three other Mn(II) centers to Mn(III). The closely related complex [Mn₉(2poap)₆](ClO₄)₆.18H₂O (10) shows similar electrochemical behavior, with a broad, quasi-reversible four electron wave at E_{1/2}=0.69 V (ΔEₚ=144 mV), and four discernible one electron waves at E_{1/2}=1.00 V (ΔEₚ=106 mV), 1.18 V (ΔEₚ=116 mV), 1.36 V (ΔEₚ=96 mV) and 1.53 V (ΔEₚ=92 mV), again associated with Mn(II) to Mn(III) oxidations.¹ The shift to slightly higher potentials for 8 is reasonably associated with the presence of the electron withdrawing chlorine atoms on the central pyridine rings in the ligand Cl2poap. The similar broad four-electron process observed for both compounds around 0.7 V is associated with oxidation of four Mn(II) centers which are fairly remote electronically, in the sense that when one is oxidized the oxidation potential of the next metal does not change significantly. The corner metal (α) sites fit this requirement. The remaining one-electron redox waves occur at successively higher potentials suggesting some communication between the metal ions. The side (β) metal ions can reasonably communicate electronically through the central Mn(II), and are assigned to these waves.

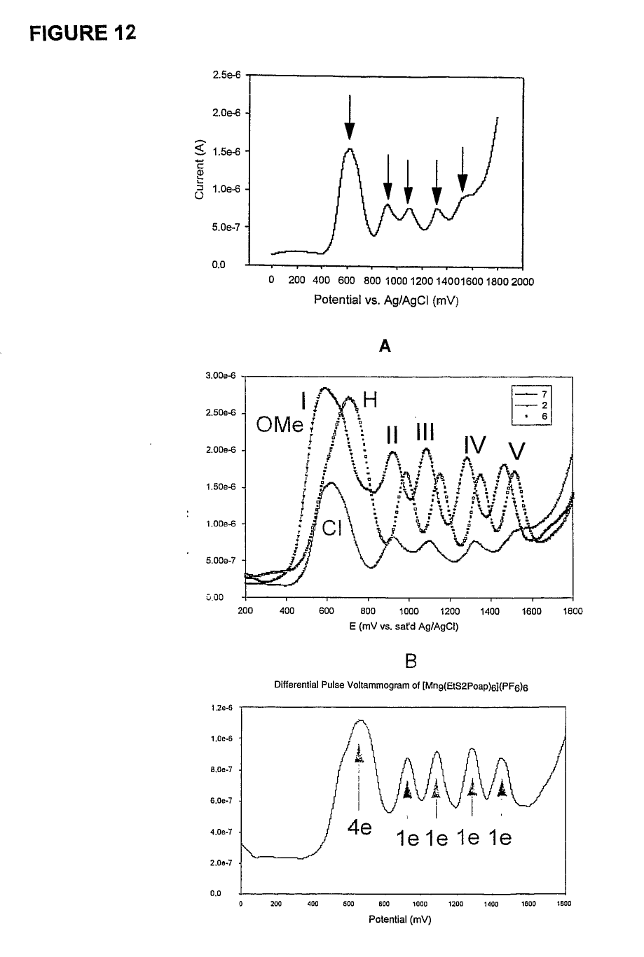

Differential pulse voltammetry reveals features associated with the individual redox steps in 8 much more clearly, as shown in FIG. 12a. Five waves show up, with some resolution of the large first wave at 630 mV (reference electrode Ag/AgCl). This indicates that the first four electrons are probably not lost in a fully concerted process. FIG. 12b compares the DPV scans for 8, 10 and 13, highlighting the significant changes in the redox properties of the grids that result when substituent R¹ is varied in formula (II), clearly indicating that the molecular electronic properties of the Mn(II)₉ grids can be ‘tuned’. FIG. 12c shows the DPV scan for 15, highlighting the important single 4-electron quasi-reversible and multiple, reversible 1-electron redox steps.

To isolate mixed oxidation state species, and check the assignment of metal site oxidation, a chemical oxidation approach was performed in which the oxidation potential of a chemical oxidant was ‘matched’ against a particular redox wave. Cl₂(aq) (E₀=1.36 V) and Br₂(aq) (E₀=1.07 V) were selected to probe the oxidation chemistry associated with the first four-electron wave only. 8 was reacted in aqueous acetonitrile with Cl₂(aq) and Br₂(aq) in the presence of added NaClO₄. However, since non-standard conditions prevail in saturated aqueous solutions of Cl₂ and Br₂, the actual potentials will be slightly different. The change in color of the solution from red-orange to dark brown, on reaction with halogen (see experimental section), is accompanied by the appearance of broad, fairly intense bands in the visible spectrum at 700 and 1000 nm (ε=400-500 M⁻¹ cm⁻¹), which are assigned to inter-valence charge transfer and LMCT bands respectively, and clearly support oxidation of some Mn(II) centers. The isolation of 6 and 7, and the structural solution for 6, shows that the broad wave at ˜0.7 V is associated with oxidation of the corner Mn(II) centers to Mn(III), as predicted. It was observed that only three metal ions have been oxidized, despite the use of excess oxidant in the case of both Cl₂ and Br₂, but the increasing cationic charge accompanying successive oxidation steps will clearly affect the successive equilibrium steps in the overall oxidation process. Other chemical oxidants, e.g. Ce(IV), OXONE®, KMnO₄, and K₂Cr₂O₇were tried, but a clean reaction was obtained only with Ce(IV), producing brown crystals, which were unsuitable for a structural determination. The removal of more than four electrons from the grid has been found to require the use of stronger oxidants, and as such the capacity of a single grid to act as an electron reservoir is increased.

Bulk electrolysis has however proven to be a method for cleanly oxidizing the grids, and using a potential of ˜1.8 V (vs. Ag/AgCl) in a three electrode cell with a solution of [Mn₉(Cl2poap)](ClO₄)₆.8H₂O (8) in aqueous acetonitrile, has produced the complex [Mn₉(Cl2poap)](ClO₄)₉.6H₂O (9), which appears to be identical to 6 and 7 (identical infrared spectra, good elemental analysis), with the oxidation of just three Mn(II) centers. Applying larger potentials with [Mn₉(2poap)₆](ClO₄)₆.18H₂O (10) has successfully produced the four electron oxidized species [Mn₉(2poap-2H)₆](ClO₄)₁₀.10H₂O (14).

The complex [Mn₉(2poapz)₆](ClO₄)₆.10.5H₂O (11), which has the same grid cation as that found in 3, exhibits three clearly defined waves (CH₃CN, 2.4×10⁻⁴ M, 0.1 M TEAP, scan rate 65 mV/s, vs. SSCE)) at E_{1/2}=0.86 V (four electrons from CPE), E_{1/2}=1.29 V (one electron) and E_{1/2}=1.47 V (one electron). The significant positive shifts in these waves compared with 10 is clearly associated with the presence of terminal pyrazine rings rather than pyridine rings, which are somewhat weaker donors, and would tend to make the metal ions more electropositive. Cyclic voltammetry on 4 in acetonitrile shows similar regions of electrochemical activity, but with poorly defined redox waves overall. This may be attributed to the highly distorted nature of this complex. Compound 5 was not soluble enough in acetonitrile to study its electrochemistry, and a solution in DMSO showed no electrochemical response.

### Example 7

### Studies on the Magnetic Properties of the Mn(II)₉ Grids

In general the Mn(II)₉ grids exhibit magnetic properties which are dominated by intramolecular anti-ferromagnetic exchange coupling, with room temperature magnetic moments in the range 16-17 μ_{B}, dropping to around 6 μ_{B} at 2 K. The magnetic ground state has been shown to be S=5/2 in the case of [Mn₉(2poap)₆](ClO₄)₆.18H₂O (10), with the anti-ferromagnetic exchange coupling in the outer ring of eight Mn(II) centers dominating the exchange situation (FIG. 1c; J>>J′).¹ Magnetization studies as a function of field have shown that upper excited states in the complex spin manifold are populated with increasing field beginning at ˜3 T, and torque studies have shown a field induced level crossing at ˜7.5 T, accompanied by an abrupt change of magnetic anisotropy from easy-axis to hard-axis type. A similar high field population of upper excited states has been observed for the linear trinuclear complex [Mn₃(CH₃COO)₆ (bpy)₂], where the spin level crossover occurs at much higher field (˜10 T).²⁵
H=−J(Σᵢ₌₁₋₇Sᵢ.Sᵢ₊₁+S₈.S₁)−J′(S₂+S₄+S₆+S₈).S₉ (1)

Assuming an idealized [3×3] grid structure the isotropic nearest neighbor exchange terms are represented by the exchange Hamiltonian shown in eqn. 1 (reference to FIG. 1c). J is the exchange coupling constant within the eight membered outer ring, and J′ the exchange coupling constant between the central Mn atom and its immediate neighbors (dipole-dipole, second order ligand field and Zeeman terms are ignored). Solving the isotropic exchange problem for a grid of this size with 45 spins and two J values (FIG. 1c) is beyond the ability of any PC computer, and even most mainframe systems, unless symmetry elements are imposed on the spin vector coupling scheme. Even imposing e.g. spin rotational and D₄ spin permutational symmetry, the matrix diagonalization problem is too large to calculate the total spin state combinations and their energies (largest dimension 22,210) using the average PC. However, a simpler alternative approach is to consider the outer ring of eight Mn(II) centers as an isolated chain (reasonable for a chain length of eight spin centers), and assume that there is effectively no coupling between the ring (chain) and the central Mn(II) ion, a model consistent with earlier studies. This can be accomplished using the Fisher model (eqns. 2, 3) for an S=5/2 chain, where the large local spin (S=5/2) is treated as a classical vector.²⁶

$$\begin{matrix}{χ}_{Mn} = \frac{{Ng}^{2} {β}^{2} S ( S + 1 ) ( 1 + u )}{3 kT ( 1 - u )} & ( 2 ) \\ u = coth [ \frac{JS ( S + 1 )}{kT} ] - [ \frac{kT}{JS ( S + 1 )} ] & ( 3 ) \\ \begin{matrix}{χ}_{mol} = [ ( 8 ⋆ {χ}_{Mn} + 1.094 ⋆ {g}^{2} ) / ( T - θ ) ] ⋆ \\ ( 1 - α ) + ( 1.094 ⋆ {g}^{2} / T ) ⋆ α + TIP\end{matrix} & ( 4 )\end{matrix}$$

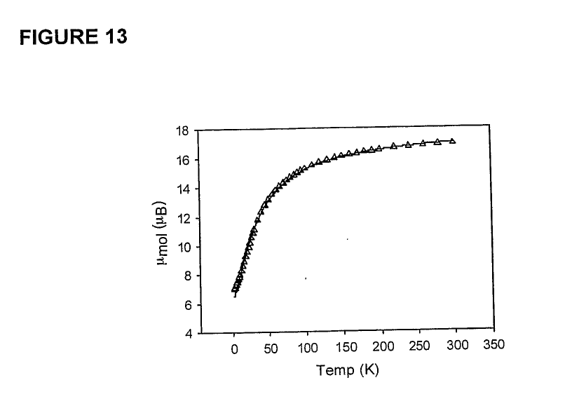

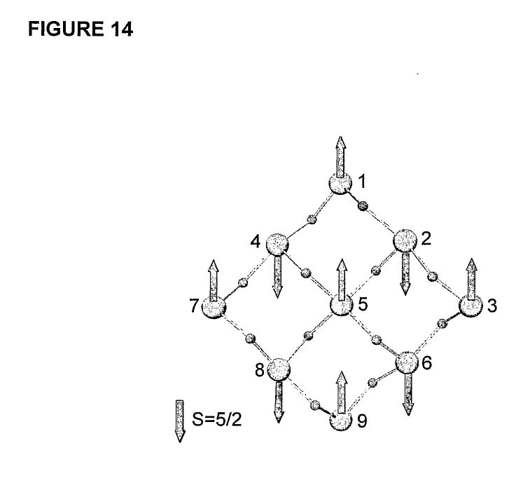

FIG. 13 illustrates the profile of magnetic moment per mole as a function of temperature for compound 1. The data were fitted to equations 2-4, with the susceptibility scaled for eight spin coupled Mn(II) centers, and corrected for temperature independent paramagnetism (TIP), paramagnetic impurity fraction (α), intermolecular exchange effects (θ—Weiss like temperature correction), and the central, ‘isolated’ Mn(II) center (eqn. 4). An excellent data fit gave g=2.028, J=−4.7 cm⁻¹, α=0.001, TIP=0, θ=0 (10²R=1.9; R=[Σ(χ_{obs.}−χ_{calc.})²/Σχ_{obs}²]^{1/2}). The solid line in FIG. 13 was calculated with these parameters. The accurate reproduction of the data over the whole temperature range indicates that the chain model is reasonable down to 2 K, and that J>>J′. A spin model for the grid, and others in this class is shown in FIG. 14, with an alternation of Mn(II) S=5/2 dipoles around the ring (chain) creating an effective S=0 ground state at low temperatures, thus resulting in an S=5/2 ground state overall when the central manganese atom is included. This result is in complete agreement with earlier studies on compound 10.

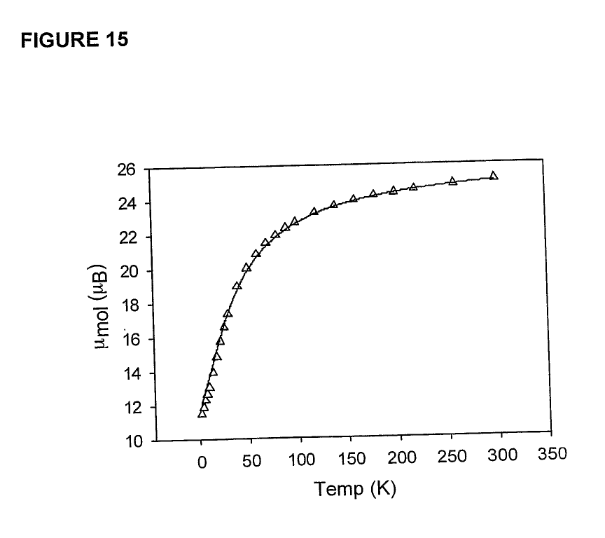

The magnetic properties of 2 combine two grid cations and two mononuclear anionic Mn(II) species. The magnetic moment per mole drops smoothly from 25.0 μ_{B} at 300 K to 11.5 μ_{B} at 2 K (similar overall profile to 1), indicating intra-molecular anti-ferromagnetic exchange within the grids. The data were fitted to eqns. 2-4, suitably adapted for two grids and two isolated monuclear Mn(II) anions to give g_{ave.}=1.992, J=−4.7 cm⁻¹, α=0.001, TIP=0, θ=−1 K (10²R=2.8) (FIG. 15). The moment value at 2 K is consistent with the presence of two isolated Mn(II) centers, and two grids with the expected S=5/2 ground states (μ_{calc.}=11.9 μ_{B}). Magnetization versus field data at 2 K show a steady increase in M to a maximum value of 20.6 Nβ at 5.0 T, consistent with the presence of the twenty spins expected for the two S=5/2 mononuclear centers and two grids with S=5/2 ground states.

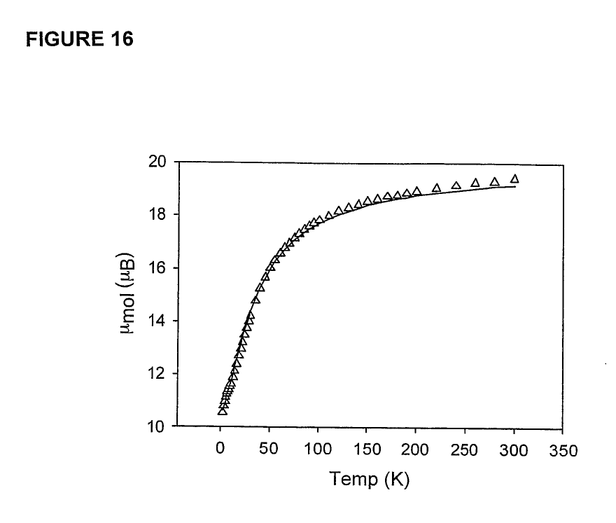

Magnetic data for 3 show typical Mn(II)₉ grid behavior with a drop in moment per mole from 15.5 μ_{B} at 300 K to 6.5 μ_{B} at 2 K. Fitting of the data to eqns. 2-4 gave g=1.95, J=−5.8 cm⁻¹, α=0.004, TIP=0, θ=−3 K, (10²R=3.2). Magnetic data for 4 show a similar drop in moment per mole from 16.7 μ_{B} at 300 K to 6.4 μ_{B} at 2 K. Fitting of the susceptibility data to eqns 2-4 gave a good fit with g=2.01, J=−4.8 cm⁻¹, α=0.001, TIP=0, θ=−2 K(10²R=1.8). Despite the quite pronounced grid distortion present in 4 (vide supra) the Mn—O—Mn angles are normal, which is consistent with the observed typical J value. Magnetic data for 5, which contains a Mn(II)₉ grid cation and two Curie-like mononuclear Mn(II) species, show a drop in moment per mole from 19.4 μ_{B} at 300 K to 10.5 μ_{B} at 2 K. The data were fitted to eqns. 2-4, adapted for the two additional mononuclear Mn(II) centers. A good data fit gave gₐᵥₑ=2.038, J=−4.1 cm⁻¹, α=0.0005, TIP=0, θ=−1 K (10²R=1.5) (FIG. 16). The good data fits for all these compounds supports the chain model. The J values for 4 and 5 are typical for grids in this class and indicate that changing the terminal donor moiety (R²=Me, Ph; FIG. 1b) has little effect on the exchange processes within the grid, and that the pronounced grid distortion present in 4 also has little impact on the exchange coupling situation within the grid.

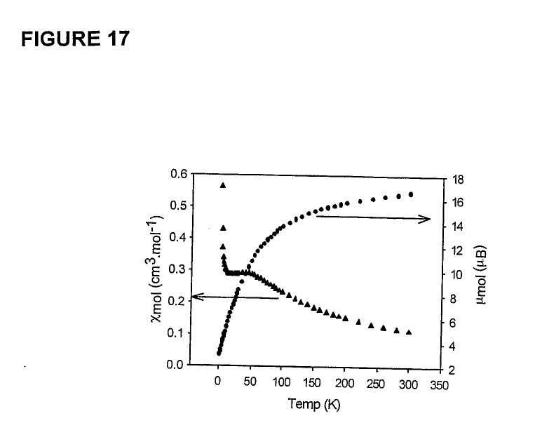

Compound 6 is a mixed oxidation state Mn(II)/Mn(III) grid system (vide ante), based on averaged metal-ligand bond lengths, and three of the corner manganese centers were found to be in the 3+ oxidation state. This would have the effect of reducing the total number of electrons in the outer ring of eight Mn centers by three, thus leading to a predictable drop in total magnetic moment. Magnetic data for 6 are shown in FIG. 17 as molar susceptibility and moment versus temperature. The pronounced maximum in χₘ at 50 K for 6 is most unusual, but is of course indicative of intramolecular anti-ferromagnetic exchange. This differs from the Mn(II)₉ grids in general, where only a shoulder appears in this region, usually at lower temperatures. The plot of μₘₒₗ versus temperature has the normal shape, confirming overall intragrid anti-ferromagnetic exchange, but the value at 2 K (2.95 μ_{B}) is much lower than normally observed for the Mn(II)₉ grids, which typically have values around 6 μ_{B}, and indicates a ground state spin considerably less than S=5/2. In fact this value is close to what would be expected for an S=1 species.

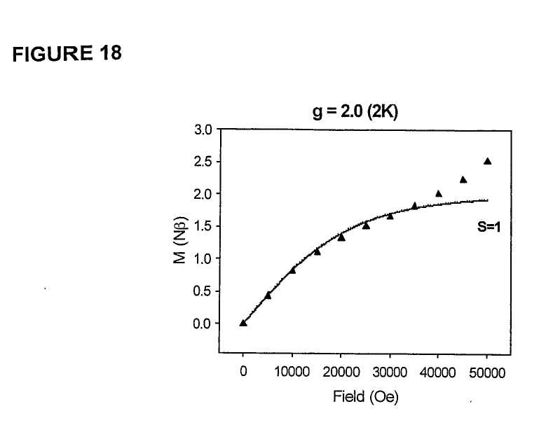

Magnetization (M) data were obtained as a function of field strength at 2 K (FIG. 18), and show an increase in magnetization to a maximum of 2.5 Nβ at 5.0 T (50,000 Oe), with a pronounced inflexion at 3.5 T. Such behavior is typical for the Mn(II)₉ grids, and is associated with population of upper levels in the complex spin manifold at higher fields. A good fit of the data in the lower field portion of the profile (<3.5 T) was obtained using a standard Brillouin function for an S=1 system (g=2.0) (solid line FIG. 18). This then defines the ground state for this complex as S=1, in agreement with μ/T data. On the assumption that all other electrons are coupled anti-ferromagnetically it is concluded that all the electrons in the outer ring of eight metal ions couple in an essentially isotropic manner, despite the presence of the three Mn(III) centers, and that the residual unpaired spins on the ring must interact anti-ferromagnetically with an equivalent number of spins on the central Mn center. This can be described by using FIG. 14 with spin vectors S=2 for atoms 1, 3 and 9. This is unexpected based on the properties of the Mn(II)₉ grids as a whole, but may result from the smaller size of three of the Mn(III) centers at the grid corners, and the overall increase in Mn—O—Mn angles, which could reasonably result in J′ now being significant in comparison with J. Because of the complexity of the mixed oxidation state exchange problem, data fitting to an exchange expression may be required. However both J and J′ (FIG. 1c) would have to be considered. Magnetic data for 7 and 9, produced by chemical oxidation of 8 with Br₂(aq), and by bulk electrochemical oxidation at 1.8 V (vide ante) respectively, are essentially identical to 6, indicating that the same mixed oxidation state grid is produced.

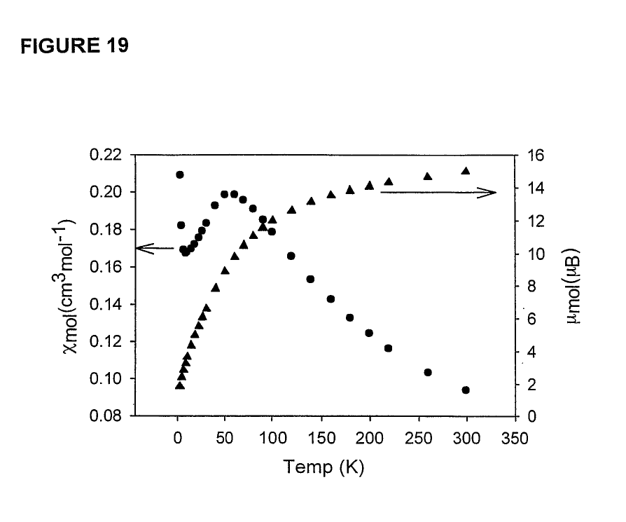

Compound 14, which has an [α(III)₄β(II)₄γ(II)] (FIG. 1c) distribution of manganese centers, has a clearly defined maximum in χₘₒₗ at a higher temperature than 6 (55 K) (FIG. 19). The moment value at 2 K (1.83 μ_{B}) is indicative of an S=1/2 ground state system, which is supported by M/H data. The room temperature moment is reasonable for a system with ‘41’ unpaired electrons, consistent with the presence of four Mn(III) centers. The magnetic properties are a clear signature of exchange throughout the whole grid, with antiferromagnetic coupling between the eight metal centers in the outer ring leading to an S=4/2 ‘ferrimagnetic’ ground state for the ring. The ring then couples antiferromagnetically to the central Mn(II) site leading to an overall ground state of S=5/2−4/2=1/2, consistent with the (d⁴)₄/(d⁵)₅ model. Clearly J and J′ (FIG. 1c) must have comparable magnitudes in this case, and indicate electronic communication throughout the whole grid.

The magnetic grid molecule Mn(II)-[3×3], in particular [Mn₉(2poap-2H)₆](ClO₄)₆3.57MeCN.H₂O, has been studied by high-field torque magnetometry at ³He temperatures. A new type of quantum magneto-oscillations in the field dependence of the magnetic torque has been observed. They are associated with level crossings which appear regularly as a function of field due to the combined effect of the magnetic interaction and the Zeeman term.

Moreover, inelastic neutron scattering has also been used to deteremine the spin excitation spectrum of the molecular grid nanomagnet Mn-[3×3], particularly [Mn₉(2poap-2H)₆](NO₃)₆.H₂O. This allows for the determination of the main features of the microscopic intracluster interactions. The ground multiplet has S=5/2, and the lowest-lying excited multiplets have (in order of increasing energy) S=7/2, S=3/2, S=9/2. These multiplets are separated by the isotropic exchange and split by the anisotropic interactions. Both the local crystal fields and the dipole-dipole interaction play an important role in determining the anisotropy of Mn(II)-[3×3].

### Example 8

### Surface Studies and Implications for “Molecular Device” Behavior

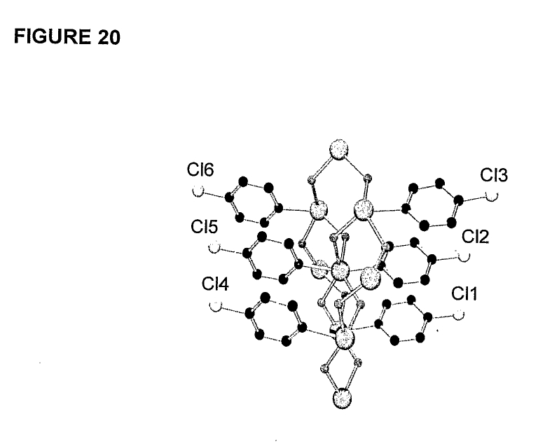

The ‘reversibility’ of the CV waves shown by 8, 10, 14 and 15 prompted consideration of the possibility of using grid molecules arranged on a surface substrate as ‘bistable’ or ‘multistable’ entities capable of existing in ‘on’ and ‘off’ redox states, and hence storing information. The structure of 8 is typical of grids in this class, with the six chlorine atoms on the 4-positions of the central pyridine rings arranged in a roughly linear array which is projected well away from the main part of the grid itself. FIG. 20 shows the core structure, and the six chlorine atoms viewed roughly perpendicular to the Mn₉(μ-O)₁₂ pseudo-plane (Cl—Cl 3.53-3.90 Å; Cl—Cl—Cl 163.5, 168.0°). The groups of three such atoms would seem ideally positioned for possible attachment of the grid molecule to a surface. Gold surfaces are relatively easy to prepare, and gold coated substrates e.g. gold CDs, are readily available. To test this notion, and to see if a surface adsorbed grid molecule can be detected using electrochemical techniques a gold foil electrode (˜3 cm² area) was used in place of platinum with complex 8 (CH₃CN, 1.1×10⁻⁴ M, 0.1 M TEAP, scan rate 50 mV/s) in the range 0-1.6 V (no electrode response in this range). Cyclic voltammetry showed two waves (E_{1/2}=˜0.6 V, ˜0.9 V), in similar regions to the waves observed with platinum, indicating a manganese based redox response. The experiment was then repeated by first immersing a cleaned gold electrode in an acetonitrile solution of 8 for several hours, followed by thorough rinsing with acetonitrile, and then running cyclic voltammetry with just pure acetonitrile (0.1 M TEAP). A significant non-electrode response was observed between 0.5 and 1.0 V, with a strong anodic wave at 1.62 V, clearly indicating the presence of electrode bound grid molecules, with the most likely points of attachment being the projecting chlorine atoms.

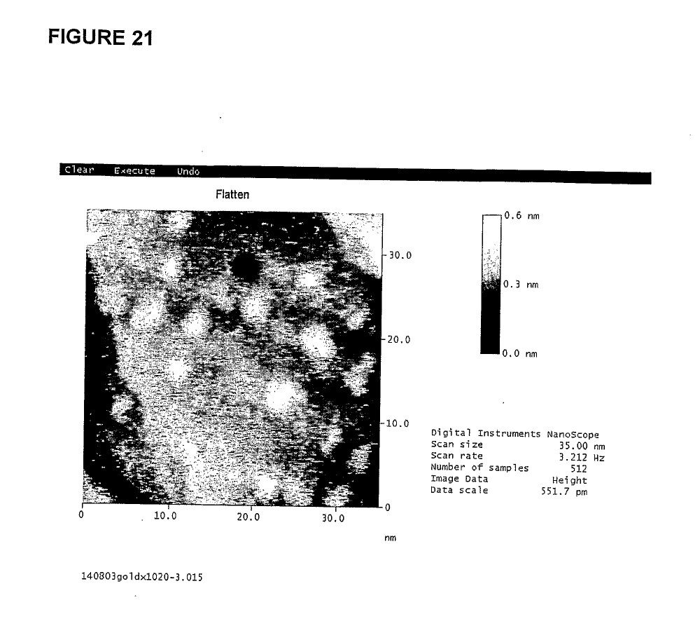

Confirmation of the ability of 8 to bind to gold has been obtained through surface imaging studies using STM (scanning tunneling microscopy) techniques (J. G. Shapter et al, Proc. SPIE, Vol. 5275, p. 59-67 (2004)), with strong binding of individual molecules in a preferred planar orientation on Au(111) (FIG. 21).

In order to enhance surface binding of the grid to e.g. gold, replacing the chlorine atoms in 8 with sulfur based groups is very useful, because of the strong affinity between gold and ‘sulfur’ groups. Ligand modifications to include e.g. S⁻ at the 4-pyridine position (S2poap; Ligand (II) m=1, n=1, R²=NH₂, R¹═S⁻R³, R³═NH₄⁺, Y═CH), were effected by conversion of ammonium 2,6-dicarbethoxypyridine-4-thiolate¹⁷ to the corresponding hydrazide, followed by condensation with the imino ester of 2-picolinic acid. Reaction of S2poap in acetonitrile with excess Mn(ClO₄)₂.6H₂O produced a red crystalline product analyzing as [Mn₉(S2poap)₆](ClO₄)₁₀.12H₂O (12). Variable temperature magnetic data show a typical room temperature moment of 16.8 μ_{B}, consistent with nine Mn(II) centers in an anti-ferromagnetically coupled grid, similar to e.g. 1, which drops to 8.3 PB at 2 K. The value at 2 K is somewhat higher than usual, and suggests a different internal exchange structure, perhaps due to the influence of the appended sulfur atoms, and their effect on the electronic situation within the grid. Complex 15, with S—CH₂CH₃ at the 4-pyridine position exhibits normal magnetic properties for Mn(II)₉ grids.

Surface studies show that when gold-coated substrates²⁷ are exposed to 10⁻⁵ to 10⁻⁷ M solutions of 12 in acetonitrile for 20-40 min. periods, monolayer assemblies of grid molecules are formed on the gold (111) surface. Surface imagery using STM techniques, and enhanced using Fourier transform methods to effectively flatten the gold surface, is illustrated in FIG. 22. Ribbons of grid molecules (bright spots) are arranged side by side, with grid dimensions of the order of 2.6×2.6 nm, with ˜3.5 nm spaces in between. Such dimensions are entirely consistent with the external size of e.g. complex 8 (˜2 nm×2 nm), estimated from crystallographic studies, and indicate that the grid cations are attached to the gold surface in a flat conformation, presumably by the sulfur atoms on the ligand central pyridine rings. FIG. 22 shows a space filling model of the Mn₉ grid cation in the chloro-complex (8) oriented in a projected flat surface arrangement. It represents a model for 12, and the green spheres are intended to represent sulfur atoms. Cross-sectional imagery at low surface coverage for 12 also reveals features which are sensibly assigned to the sulfur atoms attached to the outer grid surface. It is anticipated that compound 15 will behave in a similar manner on a gold surface.

Perchlorate anions present in 12 were not detected, and are probably beyond the resolution limit of the STM experiment. Therefore it is not possible to estimate the charged state of the surface bound grids. However conduction electrons in the gold may create regions of negative charge on the surface and compensate some, or all of the anion charge.

While the present invention has been described with reference to what are presently considered to be the preferred examples, it is to be understood that the invention is not limited to the disclosed examples To the contrary, the invention is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

### FULL CITATIONS FOR REFERENCES REFERRED TO IN THE SPECIFICATION

(1) Zhao, L.; Matthews, C. J.; Thompson, L. K.; Heath, S. L. J. Chem. Soc., Chem. Commun. 2000, 265.
(2) Zhao, L.; Xu, Z.; Thompson, L. K.; Heath, S. L.; Miller, D. O.; Ohba, M. Angew. Chem. Int. Ed. 2000, 39, 3114.
(3) Waldmann, O.; Koch, R.; Schromm, S.; Müller, P.; Zhao, L.; Thompson, L. K. Chem. Phys. Lett., 2000, 332, 73.
(4) Waldmann, O.; Zhao, L.; Thompson, L. K. Phys. Rev. Lett., 2002, 88, 066401. c
(5) Zhao, L.; Xu, Z.; Thompson, L. K.; Miller, D. O. Polyhedron, 2001, 20, 1359.
(6) Thompson, L. K.; Zhao, L.; Xu, Z.; Miller, D. O.; Reiff, W. M. Inorg. Chem. 2003, 42,128.
(7) Xu, Z.; Thompson, L. K.; Miller, D. O. Polyhedron, 2002, 21, 1715.
(8) Thompson, L. K. Coord. Chem. Rev. 2002, 233-234, 193.
(9) Xu, Z.; Thompson, L. J.; Miller, D. O. J. Chem. Soc., Chem. Commun. 2001, 1170.
(10) Zhao, L.: Thompson, L. K.; Miller, D. O.; Stirling, D. R. J. Chem. Soc., Dalton Trans. 2001, 1706.
(11) Milway, V. A.; Zhao, L.; Abedin, T. S. M.; Thompson, L. K.; Xu, Z. Polyhedron, 2003, 22, 1271.
(12) Abedin, T. S. M.; Thompson, L. K.; Miller, D. O.; Krupicka, E. J. Chem. Soc., Chem. Commun. 2003, 708.
(13) Baxter, P. N. W.; Lehn, J-M.; Fischer, J.; Youinou, M-T. Angew. Chem. Int. Ed. 1994, 33, 2284.
(14) Barboiu, M.; Vaughan, G.; Graff, R.; Lehn, J-M. J. Am. Chem. Soc. 2003, 125, 10257.
(15) Onions, S. T.; Franklin, A. M.; Horton, P. N.; Hursthouse, M. B.; Matthews, C. J. J. Chem. Soc., Chem. Commun. 2003, 2864.
(16) Weeks, L.; Thompson, L. K.; Shapter, J. G.; Pope, K. J.; Xu, Z. J. Microscopy, 2003, 212, 102.
(17) Markees, D. G.; J. Org. Chem. 1963, 28, 2530.
(18) SHELX97: Sheldrick, G. M. (1997).
(19) SIR97: Altomare, A.; Cascarano, M.; Giacovazzo, C.; Guagliardi, A; J. Appl. Cryst., 1993, 26, 343.
(20) DIRDIF94: Beurskens, P. T.; Admiraal, G.; Beurskens, G.; Bosman, W. P.; de Gelder, R.; Israel, R.; Smits, J. M. M. (1994) The DIRDIF-94 program system, Technical Report of the Crystallography Laboratory, University of Nijmegen, The Netherlands.
(21) Cromer, D. T.; Waber, J. T. “International Tables for X-ray Crystallography”, Vol. IV, The Kynoch Press, Birmingham, England, Table 2.2 A (1974).
(22) Ibers, J. A.; Hamilton, W. C. Acta Crystallogr., 1964, 17, 781.
(23) Creagh, D. C.; McAuley, W. J. “International Tables for Crystallography”, Vol C, (A. J. C. Wilson, ed.), Kluwer Academic Publishers, Boston, Table 4.2.6.8, pages 219-222 (1992).
(24) teXsan for Windows: Crystal Structure Analysis Package; Molecular Structure Corp., 1997.
(25) Ménage, S.; Vitols, S. E.; Bergerat, P.; Codjovi, E. ; Kahn, O.; Girerd, J.-J.; Guillot, M.; Solans, X.; Calvet. Inorg. Chem. 1991, 30, 2666.
(26) Fisher, M. E. Am. J. Phys. 1964, 32, 343.

(27) Mazurkiewicz, J. H.; Mearns, F. J.; Losic, D.; Weeks, L.; Waclawik, E. R.; Rogers, C. T.; Shapter, J. G.; Gooding, J. J. J. Vacuum Science and Technology, 2002, B20, 2265.

TABLE 1
Summary of crystallographic data for 1-6

| | Compound | | |
|---|---|---|---|
| | 1 | 2 | 3 |
| Empirical formula | C₁₂₂H₁₃₄N₆₆O₃₂Mn₉ | C₂₄₂H₂₃₃N₁₂₁O₅₀S₁₃Mn₂₀ | C₁₀₅H₁₂₇N₇₁O₄₃Mn₉ |
| M | 3531.27 | 7151.82 | 3566.05 |
| Crystal System | tetragonal | triclinic | triclinic |
| Space group | P4₂/n | Pi (#2) | Pi(#2) |
| a/Å | 21.568(1) | 25.043(1) | 18.1578(12) |
| b/Å | | 27.413(1) | 18.2887(12) |
| c/Å | 16.275(1) | 27.538(2) | 26.764(2) |
| α/° | 90 | 91.586(2) | 105.7880(12) |
| β/° | 90 | 113.9200(9) | 101.547(2) |
| γ/° | 90 | 111.9470(8) | 91.1250(11) |
| V/A³ | 7570.6(7) | 15667(1) | 8353.6(8) |
| ρ_{calcd}(g cm⁻³) | 1.549 | 1.516 | 1.418 |
| T/K | 193(1) | 193(1) | 193(1) |
| Z | 2 | 2 | 2 |
| μ/cm⁻¹ | 8.19 | 9.48 | 7.48 |
| Reflections collected: | | | |
| total, unique, Rᵢₙₜ, | 49927, 7768, 0.067 | 78112, 63600, 0.038 | 42722, 31487, 0.052 |
| Obs (I > 2.00σ(I)) | 5821 | 63600 | 14527 |
| Final R₁, wR₂ | 0.096, 0.262 | 0.093, 0.334 | 0.134, 0.429 |
| | Compound | | |
| | 4 | 5 | 6 |
| Empirical formula | C₁₈₆H₁₃₈N₄₆O₃₀Mn₉ | C₁₂₆H₁₁₈N₄₂O₂₀Cl₁₀Mn₁₁ | C₁₁₄H₉₈N₅₄O₅₅Cl₁₅Mn₉ |
| M | 3991.87 | 3499.44 | 4130.67 |
| Crystal System | tetragonal | tetragonal | triclinic |
| Space group | P4₁2₁2 (#92) | I-4 (#82) | Pi |
| a/Å | 20.279(1) | 18.2700(5) | 19.044(2) |
| b/Å | | | 19.457(2) |
| c/Å | 54.873(6) | 26.753(2) | 23.978(3) |
| α/° | 90 | 90 | 84.518(3) |
| β/° | 90 | 90 | 81.227(3) |
| γ/° | 90 | 90 | 60.954(2) |
| V/A³ | 22566(2) | 8929.8(5) | 7674(2) |
| ρ_{calcd}(g cm⁻³) | 1.175 | 1.301 | 1.788 |
| T/K | 193(1) | 193(1) | 193(1) |
| Z | 4 | 2 | 2 |
| μ/cm⁻¹ | 5.54 | 9.63 | 10.83 |
| Reflections collected: | | | |
| total, unique, Rᵢₙₜ, | 125625, 23102, 0.115 | 24519, 9160, 0.030 | 37579, 30780, 0.061 |
| Obs (I > 2.00σ (I)) | 15252 | 9160 | 11233 |
| Final R₁, wR₂ | 0.111, 0.323 | 0.061, 0.195 | 0.112, 0.286 |

R₁ = Σ[|F₀| − |F_{c}|]/Σ|F₀|, wR₂ = [Σ[w(|F₀|² − |F_{c}|²)²]/Σ[w(|F₀|²)²]]^{1/2}

TABLE 2
Bond Distances (Å) and Angles (°) for 1.

| | | | |
|---|---|---|---|
| Mn1 | N3 | | 2.147(6) |
| Mn1 | N8 | | 2.165(7) |
| Mn1 | O2 | | 2.169(4) |
| Mn1 | O1 | | 2.196(4) |
| Mn1 | N1 | | 2.296(7) |
| Mn1 | N6 | | 2.319(7) |
| Mn2 | N12 | | 2.141(5) |
| Mn2 | O3 | | 2.153(4) |
| Mn2 | N5 | | 2.181(5) |
| Mn2 | O1 | | 2.184(4) |
| Mn2 | O2 | | 2.222(4) |
| Mn2 | N10 | | 2.315(6) |
| Mn3 | N14 | | 2.180(6) |
| Mn3 | O3 | | 2.190(4) |
| Mn1 | Mn2 | | 3.932(2) |
| Mn2 | Mn3 | | 3.886(2) |
| Mn1 | Mn2′ | | 3.925(2) |
| Mn2 | O1 | Mn1 | 127.7(2) |
| Mn1 | O2 | Mn2 | 126.7(2) |
| Mn2 | O3 | Mn3 | 126.93(17) |

TABLE 3
Bond Distances (Å) and Angles (°) for 2.

| Mn1 | O12 | | 2.160(6) |
|---|---|---|---|
| Mn1 | N3 | | 2.164(7) |
| Mn1 | N30 | | 2.169(7) |
| Mn1 | O6 | | 2.199(5) |
| Mn1 | N28 | | 2.281(8) |
| Mn1 | N1 | | 2.319(7) |
| Mn2 | N39 | | 2.128(7) |
| Mn2 | O8 | | 2.166(5) |
| Mn2 | N5 | | 2.177(7) |
| Mn2 | O1 | | 2.189(6) |
| Mn2 | O12 | | 2.204(5) |
| Mn2 | N37 | | 2.299(7) |
| Mn3 | N48 | | 2.136(8) |
| Mn3 | N7 | | 2.161(8) |
| Mn3 | O10 | | 2.190(6) |
| Mn3 | O1 | | 2.212(6) |
| Mn3 | N9 | | 2.309(8) |
| Mn3 | N46 | | 2.369(7) |
| Mn4 | N12 | | 2.142(7) |
| Mn4 | O2 | | 2.152(6) |
| Mn4 | O6 | | 2.193(6) |
| Mn4 | N32 | | 2.198(7) |
| Mn4 | O7 | | 2.230(6) |
| Mn4 | N10 | | 2.341(8) |
| Mn5 | O2 | | 2.170(6) |
| Mn5 | O9 | | 2.170(5) |
| Mn5 | N41 | | 2.172(7) |
| Mn5 | N14 | | 2.172(6) |
| Mn5 | O8 | | 2.209(5) |
| Mn5 | O3 | | 2.211(6) |
| Mn6 | N16 | | 2.125(8) |
| Mn6 | N50 | | 2.156(8) |
| Mn6 | O3 | | 2.159(5) |
| Mn6 | O11 | | 2.173(6) |
| Mn6 | O10 | | 2.215(5) |
| Mn6 | N18 | | 2.282(8) |
| Mn7 | N21 | | 2.163(7) |
| Mn7 | N34 | | 2.181(7) |
| Mn7 | O7 | | 2.194(6) |
| Mn7 | O4 | | 2.198(6) |
| Mn7 | N19 | | 2.314(8) |
| Mn7 | N36 | | 2.318(7) |
| Mn8 | N43 | | 2.146(7) |
| Mn8 | O9 | | 2.169(6) |
| Mn8 | N23 | | 2.191(7) |
| Mn8 | O4 | | 2.198(6) |
| Mn8 | O5 | | 2.230(6) |
| Mn8 | N45 | | 2.317(7) |
| Mn9 | N25 | | 2.147(7) |
| Mn9 | N52 | | 2.160(7) |
| Mn9 | O5 | | 2.184(6) |
| Mn9 | O11 | | 2.204(6) |
| Mn9 | N54 | | 2.313(7) |
| Mn9 | N27 | | 2.353(7) |
| Mn10 | N57 | | 2.150(8) |
| Mn10 | N84 | | 2.153(8) |
| Mn10 | O19 | | 2.180(6) |
| Mn10 | O13 | | 2.184(6) |
| Mn10 | N55 | | 2.320(9) |
| Mn10 | N82 | | 2.368(7) |
| Mn11 | N93 | | 2.123(7) |
| Mn11 | N59 | | 2.176(7) |
| Mn11 | O21 | | 2.180(5) |
| Mn11 | O13 | | 2.194(6) |
| Mn11 | O14 | | 2.231(6) |
| Mn11 | N91 | | 2.407(7) |
| Mn12 | N102 | | 2.146(7) |
| Mn12 | N61 | | 2.160(7) |
| Mn12 | O14 | | 2.182(6) |
| Mn12 | O23 | | 2.188(5) |
| Mn12 | N63 | | 2.323(8) |
| Mn12 | N100 | | 2.399(7) |
| Mn13 | N66 | | 2.142(7) |
| Mn13 | N86 | | 2.169(7) |
| Mn13 | O15 | | 2.176(5) |
| Mn13 | O20 | | 2.198(6) |
| Mn13 | O19 | | 2.223(6) |
| Mn13 | N64 | | 2.318(7) |
| Mn14 | N68 | | 2.172(7) |
| Mn14 | N95 | | 2.178(7) |
| Mn14 | O22 | | 2.200(5) |
| Mn14 | O16 | | 2.211(6) |
| Mn14 | O21 | | 2.231(5) |
| Mn14 | O15 | | 2.243(5) |
| Mn15 | N70 | | 2.148(7) |
| Mn15 | N104 | | 2.184(7) |
| Mn15 | O16 | | 2.192(5) |
| Mn15 | O24 | | 2.201(5) |
| Mn15 | O23 | | 2.243(5) |
| Mn15 | N72 | | 2.377(7) |
| Mn16 | N75 | | 2.137(7) |
| Mn16 | N88 | | 2.166(7) |
| Mn16 | O20 | | 2.190(6) |
| Mn16 | O17 | | 2.218(6) |
| Mn16 | N73 | | 2.284(7) |
| Mn16 | N90 | | 2.294(8) |
| Mn17 | N97 | | 2.148(7) |
| Mn17 | O22 | | 2.160(5) |
| Mn17 | N77 | | 2.183(7) |
| Mn17 | O17 | | 2.201(5) |
| Mn17 | O18 | | 2.274(5) |
| Mn17 | N99 | | 2.277(7) |
| Mn18 | N79 | | 2.145(8) |
| Mn18 | N106 | | 2.149(7) |
| Mn18 | O18 | | 2.160(5) |
| Mn18 | O24 | | 2.211(5) |
| Mn18 | N108 | | 2.286(7) |
| Mn18 | N81 | | 2.346(7) |
| Mn19 | N111 | | 2.096(10) |
| Mn19 | N112 | | 2.097(10) |
| Mn19 | N110 | | 2.116(9) |
| Mn19 | N109 | | 2.191(10) |
| Mn19 | O25 | | 2.273(9) |
| Mn20 | N121 | | 1.955(2) |
| Mn20 | N122 | | 2.041(2) |
| Mn20 | N114 | | 2.066(11) |
| Mn20 | N115 | | 2.077(11) |
| Mn20 | O26 | | 2.175(17) |
| Mn2 | O1 | Mn3 | 129.0(3) |
| Mn4 | O2 | Mn5 | 129.3(3) |
| Mn6 | O3 | Mn5 | 127.2(3) |
| Mn7 | O4 | Mn8 | 128.0(3) |
| Mn9 | O5 | Mn8 | 129.1(3) |
| Mn4 | O6 | Mn1 | 128.0(3) |
| Mn7 | O7 | Mn4 | 126.7(3) |
| Mn2 | O8 | Mn5 | 126.9(3) |
| Mn8 | O9 | Mn5 | 127.2(3) |
| Mn3 | O10 | Mn6 | 127.9(3) |
| Mn6 | O11 | Mn9 | 127.8(3) |
| Mn1 | O12 | Mn2 | 125.7(2) |
| Mn10 | O13 | Mn11 | 127.9(3) |
| Mn12 | O14 | Mn11 | 127.0(3) |
| Mn13 | O15 | Mn14 | 128.1(2) |
| Mn15 | O16 | Mn14 | 128.9(3) |
| Mn17 | O17 | Mn16 | 128.9(3) |
| Mn18 | O18 | Mn17 | 128.2(3) |
| Mn10 | O19 | Mn13 | 129.1(3) |
| Mn16 | O20 | Mn13 | 127.8(3) |
| Mn11 | O21 | Mn14 | 130.3(3) |
| Mn17 | O22 | Mn14 | 126.9(3) |
| Mn12 | O23 | Mn15 | 131.1(3) |
| Mn15 | O24 | Mn18 | 128.0(3) |

TABLE 4
Bond Distances (Å) and Angles (°) for 3.

| Mn1 | N4 | | 2.110(13) |
|---|---|---|---|
| Mn1 | N37 | | 2.142(11) |
| Mn1 | O1 | | 2.159(8) |
| Mn1 | O7 | | 2.174(8) |
| Mn1 | N34 | | 2.362(12) |
| Mn1 | N2 | | 2.502(2) |
| Mn2 | O9 | | 2.140(7) |
| Mn2 | N48 | | 2.164(8) |
| Mn2 | N6 | | 2.198(9) |
| Mn2 | O2 | | 2.203(8) |
| Mn2 | O1 | | 2.219(8) |
| Mn2 | N45 | | 2.405(10) |
| Mn3 | N59 | | 2.108(10) |
| Mn3 | O11 | | 2.151(7) |
| Mn3 | O2 | | 2.157(8) |
| Mn3 | N8 | | 2.177(10) |
| Mn3 | N56 | | 2.346(10) |
| Mn3 | N10 | | 2.348(11) |
| Mn4 | N15 | | 2.127(9) |
| Mn4 | O3 | | 2.137(7) |
| Mn4 | N39 | | 2.161(9) |
| Mn4 | O7 | | 2.170(8) |
| Mn4 | O8 | | 2.190(7) |
| Mn4 | N12 | | 2.367(11) |
| Mn5 | N50 | | 2.169(7) |
| Mn5 | N17 | | 2.181(8) |
| Mn5 | O4 | | 2.184(7) |
| Mn5 | O10 | | 2.194(7) |
| Mn5 | O3 | | 2.198(7) |
| Mn5 | O9 | | 2.226(7) |
| Mn6 | N19 | | 2.151(8) |
| Mn6 | O4 | | 2.159(7) |
| Mn6 | N61 | | 2.169(8) |
| Mn6 | O12 | | 2.197(7) |
| Mn6 | O11 | | 2.228(7) |
| Mn6 | N21 | | 2.381(10) |
| Mn7 | N41 | | 2.111(9) |
| Mn7 | O5 | | 2.157(7) |
| Mn7 | N26 | | 2.160(9) |
| Mn7 | O8 | | 2.181(8) |
| Mn7 | N23 | | 2.315(9) |
| Mn7 | N43 | | 2.372(10) |
| Mn8 | N52 | | 2.120(8) |
| Mn8 | O10 | | 2.147(7) |
| Mn8 | N28 | | 2.179(7) |
| Mn8 | O5 | | 2.190(7) |
| Mn8 | O6 | | 2.213(7) |
| Mn8 | N54 | | 2.378(10) |
| Mn9 | N63 | | 2.147(8) |
| Mn9 | N30 | | 2.149(8) |
| Mn9 | O6 | | 2.150(6) |
| Mn9 | O12 | | 2.152(7) |
| Mn9 | N65 | | 2.301(9) |
| Mn9 | N32 | | 2.347(9) |
| Mn1 | O1 | Mn2 | 128.3(4) |
| Mn3 | O2 | Mn2 | 127.0(3) |
| Mn4 | O3 | Mn5 | 128.5(3) |
| Mn6 | O4 | Mn5 | 128.2(3) |
| Mn7 | O5 | Mn8 | 127.7(3) |
| Mn9 | O6 | Mn8 | 127.5(3) |
| Mn4 | O7 | Mn1 | 128.4(4) |
| Mn7 | O8 | Mn4 | 127.9(3) |
| Mn2 | O9 | Mn5 | 128.6(3) |
| Mn8 | O10 | Mn5 | 128.7(3) |
| Mn3 | O11 | Mn6 | 128.3(3) |
| Mn9 | O12 | Mn6 | 127.2(3) |

TABLE 5
Bond Distances (Å) and Angles (°) for 4.

| Mn1 | O1 | | 2.155(6) |
|---|---|---|---|
| Mn1 | O4 | | 2.169(6) |
| Mn1 | N2 | | 2.174(8) |
| Mn1 | N10 | | 2.177(8) |
| Mn1 | N9 | | 2.292(8) |
| Mn1 | N1 | | 2.300(8) |
| Mn2 | O6 | | 2.175(6) |
| Mn2 | N4 | | 2.180(7) |
| Mn2 | N16 | | 2.233(7) |
| Mn2 | O1 | | 2.246(6) |
| Mn2 | O2 | | 2.253(6) |
| Mn2 | N15 | | 2.278(7) |
| Mn3 | O2 | | 2.163(6) |
| Mn3 | O2 | | 2.163(6) |
| Mn3 | N20 | | 2.182(7) |
| Mn3 | N20 | | 2.182(7) |
| Mn3 | N19 | | 2.272(8) |
| Mn3 | N19 | | 2.272(8) |
| Mn4 | O3 | | 2.150(6) |
| Mn4 | N12 | | 2.160(7) |
| Mn4 | O5 | | 2.210(6) |
| Mn4 | N6 | | 2.220(7) |
| Mn4 | O4 | | 2.229(6) |
| Mn4 | N5 | | 2.273(8) |
| Mn5 | N18 | | 2.159(6) |
| Mn5 | N18 | | 2.159(6) |
| Mn5 | O3 | | 2.231(6) |
| Mn5 | O3 | | 2.231(6) |
| Mn5 | O6 | | 2.233(6) |
| Mn5 | O6 | | 2.233(6) |
| Mn6 | O5 | | 2.174(6) |
| Mn6 | O5 | | 2.174(6) |
| Mn6 | N14 | | 2.184(8) |
| Mn6 | N14 | | 2.184(8) |
| Mn6 | N8 | | 2.270(8) |
| Mn6 | N8 | | 2.270(8) |
| Mn1 | O1 | Mn2 | 128.0(3) |
| Mn3 | O2 | Mn2 | 127.3(3) |
| Mn4 | O3 | Mn5 | 128.0(3) |
| Mn1 | O4 | Mn4 | 125.6(3) |
| Mn6 | O5 | Mn4 | 125.7(3) |
| Mn2 | O6 | Mn5 | 127.4(3) |

TABLE 6
Bond Distances (Å) and Angles (°) for 5.

| Mn1 | O1 | | 2.172(4) |
|---|---|---|---|
| Mn1 | N6 | | 2.172(5) |
| Mn1 | O2 | | 2.181(3) |
| Mn1 | N2 | | 2.196(5) |
| Mn1 | N7 | | 2.256(4) |
| Mn1 | N1 | | 2.286(4) |
| Mn2 | O3 | | 2.153(3) |
| Mn2 | N9 | | 2.176(5) |
| Mn2 | N4 | | 2.180(5) |
| Mn2 | O2 | | 2.200(3) |
| Mn2 | O1 | | 2.230(3) |
| Mn2 | N8 | | 2.286(5) |
| Mn3 | N11 | | 2.180(6) |
| Mn3 | O3 | | 2.199(3) |
| Mn4 | Cl1 | | 2.3674(14) |
| Mn4 | Cl1 | | 2.3674(14) |
| Mn4 | Cl1 | | 2.3675(14) |
| Mn4 | Cl1 | | 2.3675(14) |
| Mn5 | Cl2 | | 2.3647(19) |
| Mn5 | Cl2 | | 2.3647(19) |
| Mn5 | Cl2 | | 2.3648(19) |
| Mn5 | Cl2 | | 2.3648(19) |
| Mn1 | O1 | Mn2 | 128.52(18) |
| Mn1 | O2 | Mn2 | 128.38(18) |
| Mn2 | O3 | Mn3 | 127.64(16) |

TABLE 7
Bond Distances (Å) and Angles (°) for 6.

| Mn1 | N30 | | 1.947(8) |
|---|---|---|---|
| Mn1 | N3 | | 1.971(9) |
| Mn1 | O7 | | 2.031(6) |
| Mn1 | N28 | | 2.092(8) |
| Mn1 | O1 | | 2.150(8) |
| Mn1 | N1 | | 2.204(11) |
| Mn2 | N39 | | 2.095(8) |
| Mn2 | N5 | | 2.164(8) |
| Mn2 | O9 | | 2.184(7) |
| Mn2 | O2 | | 2.220(8) |
| Mn2 | O1 | | 2.227(8) |
| Mn2 | N37 | | 2.279(8) |
| Mn3 | N7 | | 1.943(10) |
| Mn3 | N48 | | 1.962(9) |
| Mn3 | O2 | | 2.030(8) |
| Mn3 | O11 | | 2.075(7) |
| Mn3 | N9 | | 2.143(11) |
| Mn3 | N46 | | 2.176(9) |
| Mn4 | N12 | | 2.129(9) |
| Mn4 | O3 | | 2.175(9) |
| Mn4 | N32 | | 2.188(8) |
| Mn4 | O8 | | 2.211(7) |
| Mn4 | O7 | | 2.249(6) |
| Mn4 | N10 | | 2.379(12) |
| Mn5 | N14 | | 2.197(8) |
| Mn5 | N41 | | 2.200(7) |
| Mn5 | O9 | | 2.220(7) |
| Mn5 | O10 | | 2.230(7) |
| Mn5 | O4 | | 2.253(9) |
| Mn5 | O3 | | 2.256(9) |
| Mn6 | N16 | | 2.079(9) |
| Mn6 | N50 | | 2.144(9) |
| Mn6 | O4 | | 2.159(8) |
| Mn6 | O12 | | 2.237(8) |
| Mn6 | N18 | | 2.255(14) |
| Mn6 | O11 | | 2.257(7) |
| Mn7 | N34 | | 2.073(9) |
| Mn7 | N21 | | 2.075(12) |
| Mn7 | O8 | | 2.129(8) |
| Mn7 | O5 | | 2.160(10) |
| Mn7 | N36 | | 2.245(9) |
| Mn7 | N19 | | 2.301(15) |
| Mn8 | N43 | | 2.092(9) |
| Mn8 | O10 | | 2.170(7) |
| Mn8 | N23 | | 2.178(10) |
| Mn8 | O5 | | 2.268(11) |
| Mn8 | O6 | | 2.293(11) |
| Mn8 | N45 | | 2.369(10) |
| Mn9 | N25 | | 1.961(13) |
| Mn9 | N52 | | 1.978(11) |
| Mn9 | O6 | | 2.045(11) |
| Mn9 | O12 | | 2.125(7) |
| Mn9 | N55 | | 2.126(16) |
| Mn9 | N27 | | 2.139(18) |
| Mn9 | N54 | | 2.329(19) |
| Mn1 | O1 | Mn2 | 133.8(3) |
| Mn3 | O2 | Mn2 | 131.2(3) |
| Mn4 | O3 | Mn5 | 130.0(3) |
| Mn6 | O4 | Mn5 | 130.0(3) |
| Mn7 | O5 | Mn8 | 129.7(4) |
| Mn9 | O6 | Mn8 | 134.3(3) |
| Mn1 | O7 | Mn4 | 132.2(3) |
| Mn7 | O8 | Mn4 | 130.0(3) |
| Mn2 | O9 | Mn5 | 129.4(3) |
| Mn8 | O10 | Mn5 | 131.0(3) |
| Mn3 | O11 | Mn6 | 134.3(3) |
| Mn9 | O12 | Mn6 | 135.1(4) |

1. A square supramolecular metal coordination grid comprising the formula (I):
[Mₐ_{²}(L)₂ₐ]X_{z} (I)
in which
M is a transition metal;
a is 3, 4, 5 or 6;
X is a counterion; and
z is 2 to 60;
L is selected from at least one of the formulas: 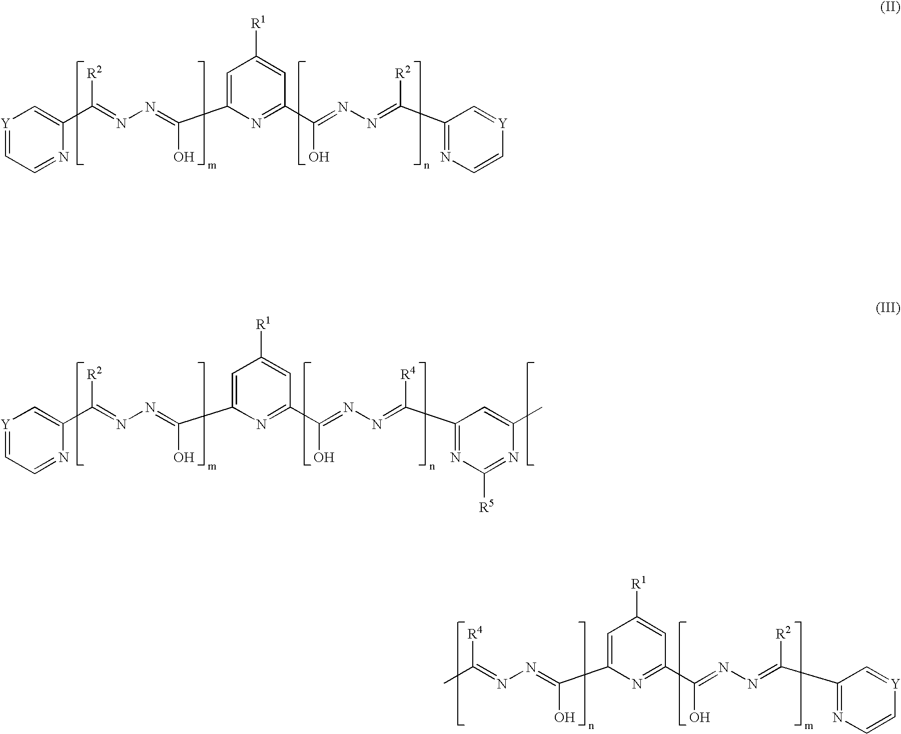
in which
Y is CH or N;
R¹ is selected from the group consisting of H, Cl, Br, I, OH, C₁₋₆alkyl, (O)C₁₋₆alkyl, S⁻ or SR³;
R² is selected from the group consisting of H, NH₂, C₁₋₆alkyl, aryl and heteroaryl, said latter three groups being optionally substituted;
R³ is selected from the group consisting of NH₄⁺, C₁₋₆alkylCOOH, C₁₋₆alkyl, C₁₋₆alkylaryl, aryl and heteroaryl, said latter five groups being optionally substituted;
R⁴ is H, NH₂, C₁₋₆alkyl, aryl and heteroaryl, said latter three groups being optionally substituted;
R⁵ is selected from the group consisting of H, NH₂, OH, C₁₋₆alkyl, aryl and heteroaryl, said latter three groups being optionally substituted;
m and n is independently selected from 1 or 2 when L is of the formula (II);
m is 0 and n is 1 or 2 when L is of the formula (III) or m is 1 and n is 1 when L is of the formula (III);
with the proviso that the sum of m and n is one less than the value of a when L is of the formula (II);
with the proviso that the sum of m and n is two less than the value of a when L is of the formula (III), and;
with the proviso that when m is 0, Y is CH.

2. The square supramolecular metal coordination grid according to claim 1, wherein M is selected from the group consisting of Mn, Fe, Co, Ni, and Cu.

3. The square supramolecular metal coordination grid according to claim 1, wherein X is selected from the group consisting of Cl⁻, Br⁻, I⁻, NCS⁻, NO₃⁻, ClO₄⁻, BF₄⁻, PF₆⁻, N₃⁻, N(CN)₂⁻, CF₃SO₃⁻, and SO₄²⁻.

4. The square supramolecular metal coordination grid according to claim 1, wherein R¹ is H, Cl, OH, OCH₃, S⁻ and SR³ in which R³ is as defined in claim 1.

5. The square supramolecular metal coordination grid according to claim 1, wherein R² is selected from the group consisting of H, NH₂, CH₃, phenyl and pyridyl.

6. The square supramolecular metal coordination grid according to claim 1, wherein R² is selected from the group consisting of H, NH₂, CH₃, phenyl and pyridyl and Y is CH.

7. The square supramolecular metal coordination grid according to claim 1, wherein R² is NH₂ and Y is N.

8. The square supramolecular metal coordination grid according to claim 1, wherein R³ is selected from the group consisting of NH₄⁺, C₁₋₄alkylCOOH, C₁₋₄alkyl, benzyl, aryl and heteroaryl.

9. The square supramolecular metal coordination grid according to claim 1, wherein R¹ is SR³ in which R³ is NH₄⁺, R² is NH₂, Y is CH, m is 1, n is 1 and a is 3.

10. The square supramolecular metal coordination grid according to claim 1, wherein R¹ is SR³ in which R³ is CH₂CH₃, R² is NH₂, Y is CH, m is 1, n is 1 and a is 3.

11. A binary information recording medium comprising:
a substrate; and
a recording medium having a monolayer of a square supramolecular metal coordination grid according to claim 1 deposited on the substrate; the square supramolecular metal coordination grid has an oxidized state and a reduced state;
wherein the oxidized state and the reduced state together correspond to binary ‘on’ or ‘off’ condition.

12. The binary information recording medium according to claim 11, wherein the substrate is selected from the group consisting of gold, graphite, titanium dioxide, silicon dioxide and glass.

13. The binary information recording medium according to claim 10, wherein the square supramolecular metal coordination grid is oxidized by a chemical oxidant or a voltage.

14. The binary information recording medium according to claim 13, wherein the chemical oxidant is selected from the group consisting of chlorine, bromine, hypochlorite, cerium (IV), NOBF₄ and persulfate.

15. The binary information recording medium according to claim 13, wherein the voltage is in the range from 0 to 2 V.

16. A method of forming a binary information recording medium comprising:
providing a substrate; and
depositing a monolayer of a square supramolecular metal coordination grid according to claim 1, in which the square supramolecular metal coordination grid has an oxidized state and a reduced state;
wherein the oxidized state and the reduced state together correspond to binary ‘on’ or ‘off’ condition.

17-23. (canceled)
